(19) United States
(12) Patent Application Publication
(10) Pub. No.: US 2025/0161943 A1
(43) Pub. Date: May 22, 2025

(54) MICROFLUIDICS DEVICE AND METHOD INCLUDING BOTTOM SUBSTRATE, TOP SUBSTRATE, AND COVER PLATE

(71) Applicant: Nicoya Lifesciences Inc., Kitchener (CA)

(72) Inventors: Sebastian VON DER ECKEN, Kitchener (CA); Tanya NARAHARI, Kitchener (CA); Gordon HALL, Cambridge (CA); Arjun SUDARSAN, Carlsbad, CA (US)

(21) Appl. No.: 18/838,208

(22) PCT Filed: May 11, 2023
(86) PCT No.: PCT/CA2023/050649

§ 371 Date: Aug. 13, 2024

Related U.S. Application Data
(60) Provisional application No. 63/340,848, filed on May 11, 2022.

(51) Int. Cl. B01L 3/00

(52) U.S. Cl. CPC B01L 3/502792; B01L 3/502707; B01L 2300/022; B01L 2300/023; B01L 2300/041; B01L 2300/048; B01L 2400/0415

(57) ABSTRACT

Provided herein are devices comprising: a bottom plate comprising one or more electrodes configured for performing droplet operations in a droplet operations gap formed between the bottom plate and a top plate, the top plate having a top surface comprising one or more irregularities or protrusions such the top surface is non-planar; and a cover plate configured to be disposed over the top plate, the cover plate comprising one or more alignment features for positioning the cover plate with respect to the one or more irregularities or protrusions of the top surface of the top plate.

### CROSS-REFERENCE

This application claims the benefit of U.S. Provisional Application No. 63/340,848, filed May 11, 2022, which is hereby incorporated by reference in its entirety herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

Microfluidics systems and devices are used in a variety of applications to manipulate, process and/or analyze biological materials. Examples of microfluidics devices include droplet actuators, microfluidics cartridges, digital microfluidics (DMF) devices, DMF cartridges, droplet actuators, flow cell devices, and the like. Microfluidics devices generally include two substrates, a top substrate and a bottom substrate, arranged with a gap therebetween. In DMF applications, electrodes are associated with the substrates and arranged to conduct droplet operations via electrowetting. In electrowetting, the gap of, for example, a microfluidics cartridge may be filled with filler fluid, which can be a low-viscosity, low-surface tension oil, such as silicone oil or hexadecane.

Certain drawbacks exist with respect to microfluidics devices. In one example, the bond around the perimeter of the two substrates is often unreliable and can be prone to leakage. In another example, the more wells that are located on a DMF cartridge, the more error prone any manual pipetting process becomes. Machine vision can help to detect mistakes but cannot prevent them.

### FIELD

The subject matter relates generally to systems and devices for processing biological materials and more particularly to microfluidics device and method including a bottom substrate, a top substrate, and a cover plate.

### SUMMARY

Provided herein are microfluidics devices comprising: a bottom plate comprising one or more electrodes configured for performing droplet operations in a droplet operations gap formed between the bottom plate and a top plate, the top plate having a top surface comprising one or more irregularities or protrusions such the top surface is non-planar; and a cover plate configured to be disposed over the top plate, the cover plate comprising one or more alignment features for positioning the cover plate with respect to the one or more irregularities or protrusions of the top surface of the top plate.

In some embodiments, the cover plate is configured to apply a force to the top plate to maintain one or more one or more properties of the droplet operations gap.

In some embodiments, the one or more properties of the droplet operations gap is one or more dimensions of the droplet operations gap.

In some embodiments, the one or more dimensions of the droplet operations gap is a height of the droplet operations gap.

In some embodiments, either a top surface and/or a bottom surface of the cover plate is substantially flat.

In some embodiments, the one or more irregularities or protrusions of the top surface of the top plate corresponds to one or more features of the top plate that form a fluid path between an exterior of the microfluidics device and the droplet operations gap.

In some embodiments, the cover plate has one or more openings corresponding to one or more features of the top plate allowing access to the one or more features.

In some embodiments, the one or more features of the top plate are one or more wells or reservoirs.

In some embodiments, the cover plate is configured to reduce evaporation of a fluid deposited in the one or more wells or reservoirs of the top plate.

In some embodiments, the top plate comprises one or more vent ports for venting the droplet operations gap.

In some embodiments, the one or more vent ports are positioned over the one or more electrodes of the bottom plate.

In some embodiments, the cover plate does not form an air-tight seal with the top plate thereby allowing the one or more vent ports of the top plate to vent.

In some embodiments, when disposed thereon the cover plate and the top plate form a gap therebetween.

In some embodiments, the gap between the cover plate and top plate is configured to store or retain additional elements of the microfluidic device.

In some embodiments, the cover plate is configured to be coupled to the top plate.

In some embodiments, the cover plate is configured to be coupled to the top plate using any one of a friction fit, an adhesive bond, a snap-fit, fasteners, or any combination thereof.

In some embodiments, the cover plate is configured to interface with the top plate irrespective of the position of the one or more irregularities or protrusions.

In some embodiments, the devices further comprise a film configured to positioned over the one or more openings of the cover plate.

In some embodiments, the film is an adhesive film.

In some embodiments, the film comprises one or more layers.

In some embodiments, the film is configured to be pierced to allow access to the one or features of the top plate.

In some embodiments, the film comprises one or more sensors.

In some embodiments, the one or more sensors comprises humidity sensors, temperature sensors, cartridge-was-exposed-to-air indicators, or any combination thereof.

In some embodiments, the film may provide, contain, or store information or data using one or more guides, logos, quick response (QR) codes, near field communication (NFC) devices, barcodes, holograms, or any combination thereof.

In some embodiments, the film is configured to be removed from the cover plate thereby exposing the one or more openings of the cover plate.

In some embodiments, the one or more irregularities or protrusions of the top surface of the top plate do not extend through the one or more openings of the cover plate.

In some embodiments, cover plate has an identifier disposed on a surface of the cover plate.

In some embodiments, the identifier is a quick response (QR) code or near field communication (NFC) device.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A and FIG. 1B illustrate isometric views of an example of the presently disclosed microfluidics device including a bottom substrate, a top substrate, and a cover plate;

FIG. 2A and FIG. 2B illustrate transparent isometric top views of the microfluidics device shown in FIG. 1A and FIG. 1B and that includes a bottom substrate, a top substrate, and a cover plate;

FIG. 3 illustrates an exploded view of the microfluidics device shown in FIG. 1A and FIG. 1B and that includes a bottom substrate, a top substrate, and a cover plate;

FIG. 4 illustrates a top view, a first side view, a second side view, a first end view, and a second end view of the microfluidics device shown in FIG. 1A and FIG. 1B and that includes a bottom substrate, a top substrate, and a cover plate;

FIG. 5 illustrates a bottom view of the microfluidics device shown in FIG. 1A and FIG. 1B and that includes a bottom substrate, a top substrate, and a cover plate;

FIG. 6 illustrates an isometric top view of the microfluidics device shown in FIG. 1A and FIG. 1B but absent the cover plate;

FIG. 7 illustrates a top view, a first side view, a second side view, a first end view, and a second end view of the microfluidics device shown in FIG. 1A and FIG. 1B but absent the cover plate;

FIG. 8A and FIG. 8B illustrate top views showing an example of bonding the bottom and top substrates of the presently disclosed microfluidics device shown in FIG. 1A and FIG. 1B;

FIG. 9 illustrates a top view showing an example of bonding the bottom and top substrates of the presently disclosed microfluidics device shown in FIG. 1A and FIG. 1B;

FIG. 10A and FIG. 10B illustrate isometric views of an example of a bottom substrate of the presently disclosed microfluidics device shown in FIG. 1A and FIG. 1B;

FIG. 11 illustrates a top view, a side view, a first end view, and a second end view of the bottom substrate shown in FIG. 10A and FIG. 10B;

FIG. 12A and FIG. 12B illustrate isometric views of an example of a top substrate of the presently disclosed microfluidics device shown in FIG. 1A and FIG. 1B;

FIG. 13 illustrates a top view, a first side view, a second side view, a first end view, and a second end view of the top substrate shown in FIG. 12A and FIG. 12B;

FIG. 14 illustrates a bottom view of the top substrate shown in FIG. 12A and FIG. 12B;

FIG. 15 illustrates a bottom isometric view of the top substrate shown in FIG. 12A and FIG. 12B;

FIG. 16A and FIG. 16B illustrate isometric views of an example of a cover plate of the presently disclosed microfluidics device shown in FIG. 1A and FIG. 1B;

FIG. 17 illustrates a top view, a first side view, a second side view, a first end view, and a second end view of the cover plate shown in FIG. 16A and FIG. 16B;

FIG. 18 illustrates a bottom view of the cover plate shown in FIG. 16A and FIG. 16B;

FIG. 19 illustrates a bottom isometric view of the cover plate shown in FIG. 16A and FIG. 16B;

FIG. 20 illustrates a cross-sectional view of the presently disclosed microfluidics device shown in FIG. 1A and FIG. 1B;

FIG. 21 illustrates a cross-sectional view of the presently disclosed microfluidics device shown in FIG. 1A and FIG. 1B;

FIG. 22A through FIG. 23B illustrate certain views of various portions of the presently disclosed microfluidics device shown in FIG. 1A and FIG. 1B and showing certain features thereof;

FIG. 24A and FIG. 24B illustrate isometric views showing other examples of the cover plate of the presently disclosed microfluidics device shown in FIG. 1A and FIG. 1B;

FIG. 25 illustrates an isometric view showing other examples of the cover plate of the presently disclosed microfluidics device shown in FIG. 1A and FIG. 1B;

FIG. 26 illustrates a flow diagram of an example of a method of using the presently disclosed microfluidics device shown in FIG. 1A and FIG. 1B;

FIG. 27A through FIG. 30B illustrate isometric views of examples of stickers that may be placed on the cover plate of the presently disclosed microfluidics device shown in FIG. 1A and FIG. 1B; and

FIG. 31A, FIG. 31B, and FIG. 31C show photos of other examples of stickers that may be placed on the cover plate of the presently disclosed microfluidics device shown in FIG. 1A and FIG. 1B.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The subject matter now will be described more fully hereinafter with reference to the accompanying drawings, in which some, but not all embodiments of the subject matter are shown. Like numbers refer to like elements throughout. The subject matter may be embodied in many different forms and should not be construed as limited to the embodiments set forth herein; rather, these embodiments are provided so that this disclosure can satisfy applicable legal requirements. Indeed, many modifications and other embodiments of the subject matter set forth herein can come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims

In some embodiments, the presently disclosed subject matter provides a microfluidics device and method including a bottom substrate, a top substrate, and a cover plate.

In some embodiments, the presently disclosed subject matter provides a cover plate configured to be disposed over a top plate.

In some embodiments, the presently disclosed microfluidics device and method provide a bottom substrate and a top substrate that may be configured to be bonded together to form a droplet operations gap therebetween, and a cover plate that may be configured to be disposed over the top substrate.

In some embodiments, the presently disclosed microfluidics device and method provide a bottom substrate and a top substrate that may be configured to be bonded together and a cover plate that may be configured to be disposed over the top substrate, wherein when the cover plate is disposed over the top substrate, the cover plate may be held in a fixed position by, for example, a friction fit, an adhesive bond, a snap-fit, fasteners, or any combinations thereof.

In some embodiments, the presently disclosed microfluidics device and method provide a bottom substrate and top substrate that may have an obstacle-free optical view of a bond line region therebetween, wherein the bond line region may correspond to one or more dimensions of the droplet operations gap between the top and bottom substrates. In other embodiments, the bond line region may not correspond to the one or more dimensions of the droplet operations gap.

In some embodiments, the presently disclosed microfluidics device and method provide a bottom substrate, a top substrate, and a cover plate comprising an optical viewing window.

In some embodiments, the presently disclosed microfluidics device and method provide a bottom substrate, a top substrate, and a cover plate, wherein the device comprises a system of vents that allows ample opportunities for air and/or air bubbles to escape an oil environment of the microfluidics device.

In some embodiments, the presently disclosed microfluidics device and method provide a bottom substrate, a top substrate, and a cover plate, the device comprising a plurality of vent ports that may be sized and/or positioned optimally to allow air and/or air bubbles to escape an oil environment of the microfluidics device.

In some embodiments, the presently disclosed microfluidics device and method provide a top substrate comprising a plurality of vent ports that may be configured to increase a venting capacity of a microfluidics device. In some embodiments, the plurality of vent ports may comprise a plurality of small-slot vent ports.

In some embodiments, the presently disclosed microfluidics device and method provide a top substrate which may comprise one or more waste ports and a waste port region. In some embodiments, the one or more waste ports may be cone-shaped. In some embodiments, the cone-shaped waste ports may have an upward opening (e.g., at the nadir of the cone) configured to hold fluid. In some embodiments, the fluid held in the cone-shaped waste ports may flow out of the cone-shaped waste ports and into the waste port region.

In some embodiments, the presently disclosed microfluidics device and method provide different cover plate designs that may be customized for certain products and/or applications.

In some embodiments, the presently disclosed microfluidics device and method provide other functions, elements, and/or components in, on, and/or between the top substrate and the cover plate, such as, but not limited to, optical elements, electronics, magnetics, and the like.

In some embodiments, the presently disclosed microfluidics device and method provide different cover plate designs that may be customized to expose one or more wells (or reservoirs) of the top substrate and/or may serve as a physical barrier to block or cover one or more wells (or reservoirs) of the top substrate.

In some embodiments, the presently disclosed microfluidics device and method provide different cover plate designs that may be customized to change a standard 16-channel microfluidics device to, for example, an 8-channel, 6-channel, 4-channel, or 2-channel device without the need to change the (more complex) top substrate.

In some embodiments, the presently disclosed microfluidics device and method provide different cover plate designs that may be customized and configured for the purpose of guiding a user protocol.

In some embodiments, the presently disclosed microfluidics device and method provide a labeled sticker disposed over the cover plate that may substantially match the well pattern (e.g., the pattern of the one or more wells (or reservoirs)) of the top substrate.

In some embodiments, the presently disclosed microfluidics device and method provide a sticker that may be labeled disposed over the cover plate that may be designed to expose one or more wells (or reservoirs) of the top substrate and/or to block or cover one or more wells of the top substrate for the purpose of guiding a user.

In some embodiments, the presently disclosed microfluidics device and method provide a sticker that may be labeled disposed over the cover plate that may be customized for the purpose of guiding a user protocol.

In some embodiments, the presently disclosed microfluidics device and method provide a cover plate comprising a substantially flat surface.

In some embodiments, the presently disclosed microfluidics device and method provide a cover plate that may be configured to evenly compress the top substrate and the bottom substrate of the microfluidics device.

In some embodiments, the presently disclosed microfluidics device and method provide a cover plate that may be configured to expose and/or cover one or more wells (or reservoirs) of the top substrate.

In some embodiments, the presently disclosed microfluidics device and method provide a sticker that may be labeled configured to be applied to and/or removed from the cover plate, thereby covering and/or exposing the one or more wells (or reservoirs) present on the cover plate or the top substrate.

In some embodiments, the presently disclosed microfluidics device and method provide a cover plate that may be configured to reduce evaporation of droplets and/or filler fluid.

In some embodiments, the presently disclosed microfluidics device and method provide a cover plate that may be configured to provide thermal insulation to the microfluidics device.

### Microfluidics Device Including Bottom Substrate, Top Substrate, and Cover Plate

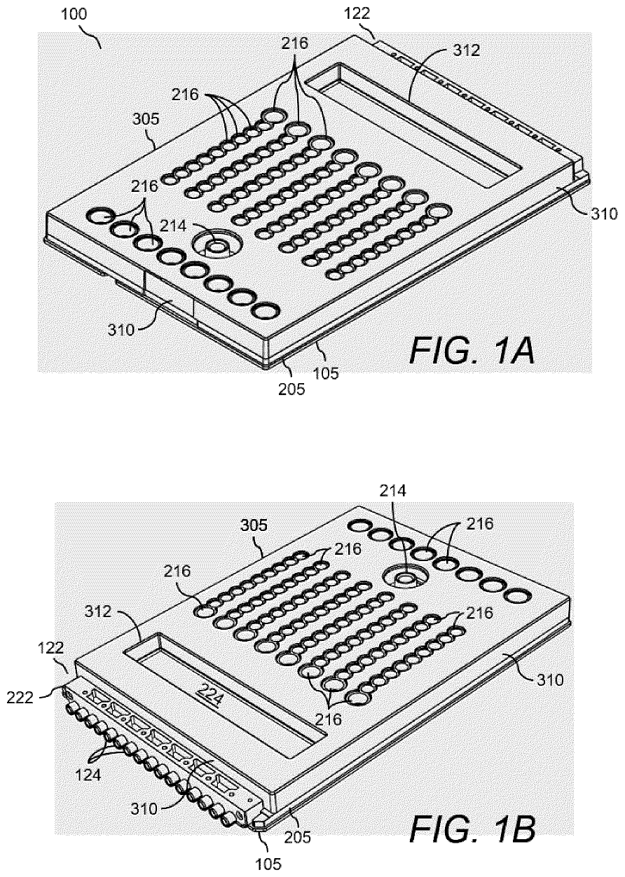

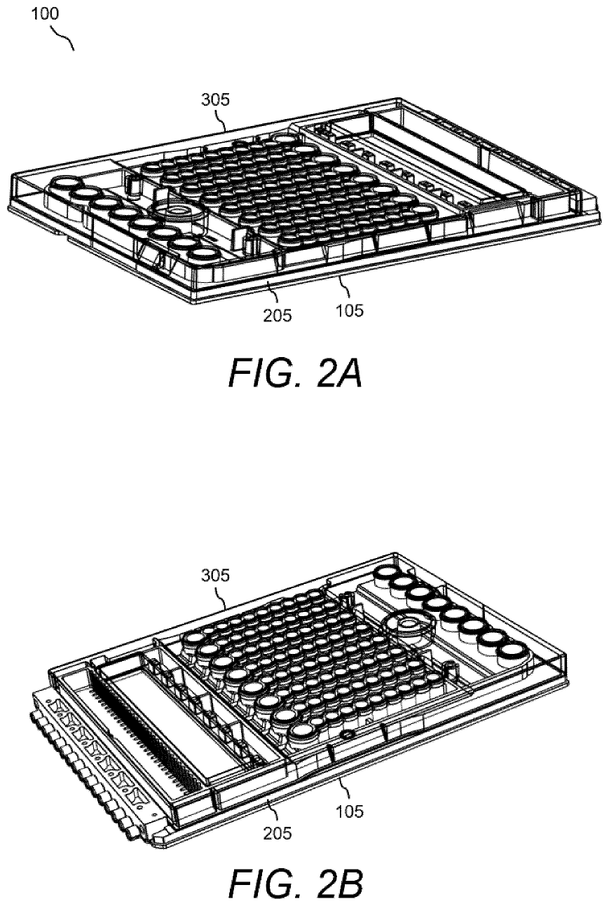

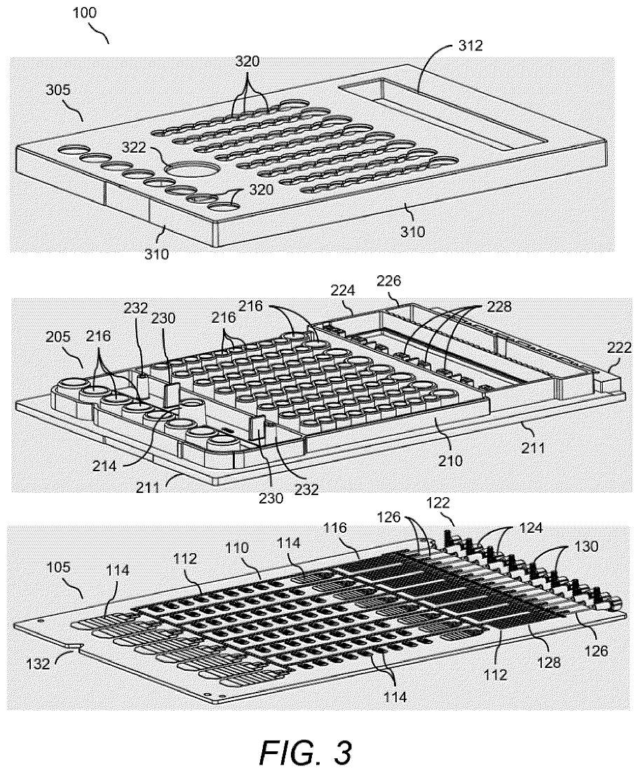

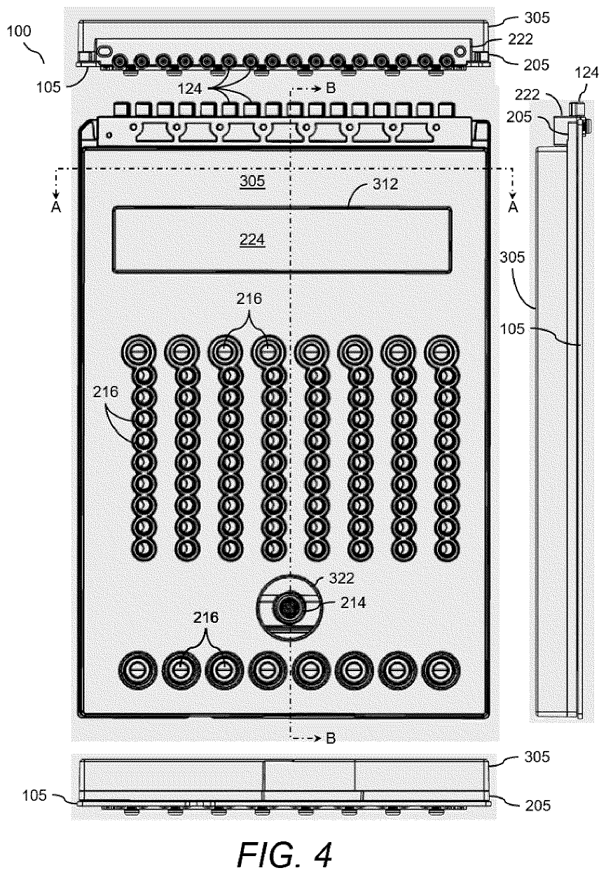

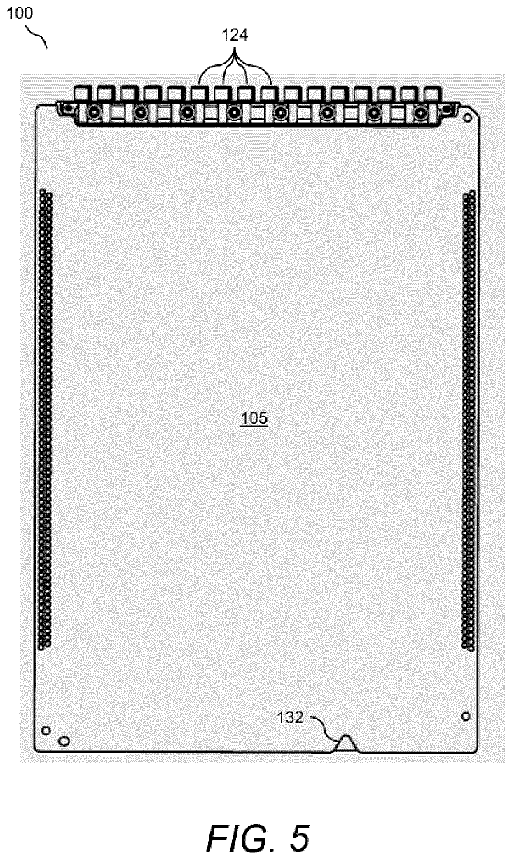

Referring now to FIG. 1A and FIG. 1B are isometric views of an example of the presently disclosed microfluidics device 100 including a bottom substrate, a top substrate, and a cover plate. Further, FIG. 2A and FIG. 2B show transparent isometric top views of microfluidics device 100 shown in FIG. 1A and FIG. 1B. Further, FIG. 3 is an exploded view of microfluidics device 100 shown in FIG. 1A and FIG. 1B. Further, FIG. 4 shows a top view, a first side view, a second side view, a first end view, and a second end view of microfluidics device 100 shown in FIG. 1A and FIG. 1B. Further, FIG. 5 is a bottom view of microfluidics device 100 shown in FIG. 1A and FIG. 1B.

Referring now to FIG. 1A through FIG. 3, the microfluidics device 100 may be, for example, any type of droplet actuator, such as, but not limited to, a microfluidics device, a microfluidics cartridge, a digital microfluidics (DMF) device, a DMF cartridge, a flow cell device, and the like. By way of example, the presently disclosed microfluidics device 100 is described hereinbelow as a DMF device or a cartridge.

In one example, microfluidics device 100 may include a bottom substrate 105, a top substrate 205, and a cover plate 305. The top substrate 205 may be positioned over the bottom substrate 105, forming a gap therebetween (not visible). In some embodiments, in the case of DMF, the bottom substrate 105 and top substrate 205 may be separated by a droplet operations gap. In some embodiments, in the case of DMF, one or more droplet operations may occur in the droplet operations gap between bottom substrate 105 and top substrate 205 of microfluidics device 100. Additionally, in some embodiments, cover plate 305 may be designed to be disposed over (e.g., sit atop) the top substrate 205.

In one example, the bottom substrate 105 may be a printed circuit board (PCB)-based substrate, such as a multi-layer PCB. In one example, bottom substrate 105 may comprise a glass or silicon substrate that may have patterned electrodes made from, for example, gold or chromium that may have been sputtered on and etched. In one example, the top substrate 205 and/or cover plate 305 may be formed of glass or plastic, or a combination thereof. For example, the top substrate 205 and/or cover plate 305 may be formed of injection molded thermoplastic materials or injection molded glass. Additionally, the top substrate 205 and/or cover plate 305 may be substantially transparent to light. In some embodiments, where the cover plate 305 and/or the top substrate 205 are substantially transparent to light, a user may visually inspect fluidic movement in the device. In some embodiments, where the cover plate 305 and/or the top substrate 205 are substantially transparent to light, a user may visually inspect droplet size movement and operations, which may provide for better error detection/measurement of errors. In some embodiments, the top substrate 205 may be substantially opaque. In some embodiments, the cover plate 305 may be substantially opaque. In some embodiments, the top substrate 205 and/or cover plate 305 may be substantially opaque. In some embodiments, where the top substrate 205 and/or the cover plate 305 are substantially opaque, one or more features (e.g., one or more wells (or reservoirs) of the top substrate 205) may be visually obscured from a user. In some embodiments, where the top substrate 205 and/or the cover plate 305 are substantially opaque, photo sensitive reagents present in the device may be protected from light. In some embodiments, where the top substrate 205 is substantially transparent to light and the cover plate 305 is substantially opaque, a user may visually inspect fluidic movements in only some areas not obscured by the cover plate 305 while protecting photo sensitive reagents. A user may also remove the cover plate 305 to visually inspect any previously obscured areas.

In one example, the bottom substrate 105 may be configured to perform one or more DMF operations (e.g., droplet operations) in the gap formed between the top substrate 205 and the bottom substrate 105. In this example, the bottom substrate 105 may comprise an electrode arrangement 110. In some embodiments, the electrode arrangement 110 may include multiple lines, paths, and/or arrays of droplet operations electrodes 112 (e.g., electrowetting electrodes) and multiple arrangements of reservoir electrodes 114. The electrode arrangement 110 may also include a mixing region 116 formed of arrays of droplet operations electrodes 112 and a sensor assembly which includes electrochemical and optical sensors. In some embodiments, the optical sensors are an optical fiber assembly 122. The optical fiber assembly 122 may include an arrangement of, for example, sixteen holding ferrules 124 and optical fibers 126. Further, in some embodiments, a sensor 128 may be provided at the distal end of each of the optical fibers 126. In some embodiments, the arrangement of, for example, sixteen holding ferrules 124 and optical fibers 126 may be held by a fiber optic connector 222 of the top substrate 205 and secured using fasteners 130 (e.g., see FIG. 3). Additionally, in some embodiments, the bottom substrate 105 may include an alignment notch 132.

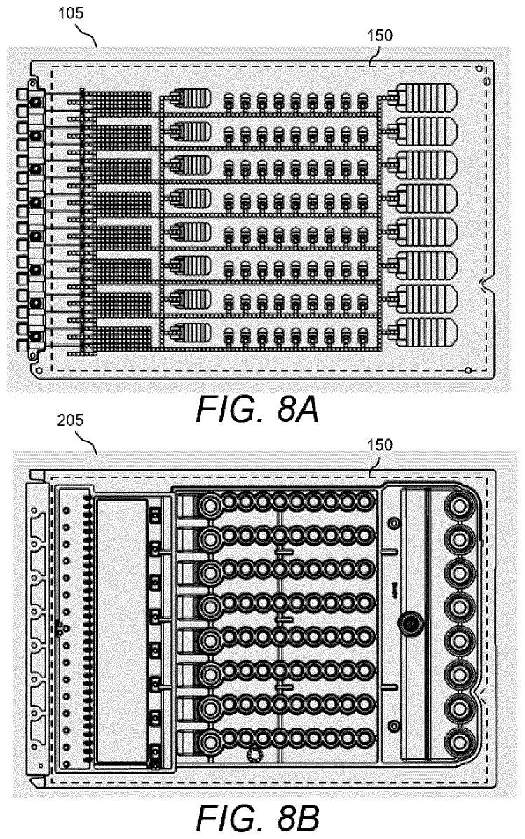

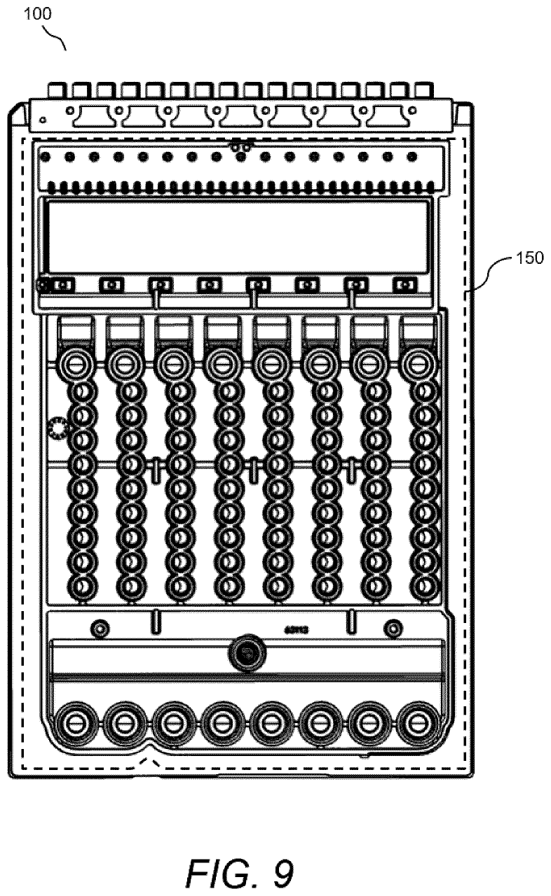

A problem of existing microfluidics devices is oil leakage. One source of oil leakage may stem from the bond interface between the bottom and top substrates. It may be difficult to directly observe the “bond line” during and/or after the bonding (e.g., adhesive bonding) process. For example, because the top substrate provides both microfluidics functions and mechanical functions (e.g., flat surface or plate with outer walls or perimeter walls), observing the bond line may be difficult because the outer perimeter wall can obstruct the view of the bond line region. By contrast, in the presently disclosed microfluidics device 100, the top substrate 205 may not include the outer wall or perimeter wall. Rather, the top substrate 205 of microfluidics device 100 may be configured to provide a clear optical view of the bond line between the bottom substrate 105 and top substrate 205. That is, in some embodiments, the presently disclosed microfluidics device 100 may provide an obstacle-free optical view of the bond line region between bottom substrate 105 and top substrate 205 (e.g., see FIG. 8A, FIG. 8B, FIG. 9).

In some embodiments, in microfluidics device 100, the cover plate 305 may include an outer wall 310. Accordingly, in some embodiments, the top substrate 205 may include an inner wall 210 in relation to an edge region 211 of top substrate 205. Here, inner wall 210 means “inner” with respect to outer wall 310 of the cover plate 305.

In microfluidics device 100, the top substrate 205 may include an inner wall 210 in relation to an edge region 211, a fluid port 214 (e.g., an oil loading port), and an arrangement of wells 216 (e.g., multiple rows or columns of wells 216, individual wells 216, and the like). The wells 216 may comprise any type of wells or reservoirs, such as, but not limited to, sample wells, reagent wells, buffer wells, waste wells, and the like. Additionally, in some embodiments, the top substrate 205 may include a fiber optic connector 222, an optical detection region 224, a waste-port region 226, a plurality of vent ports 228, multiple height-setting features (HSFs) 230, and multiple standoffs 232, all arranged as shown, for example, in FIG. 1A through FIG. 3.

In some embodiments, a sloped or ramped channel may supply each of the vent ports 228 in the plurality of vent ports. For example, in some embodiments, a line of nine vent ports 228 may be provided. In some embodiments, a line or more or less than nine vent ports may be provided. In some embodiments, an L-shaped sloped or ramped channel 240 may supply each of the inner vent ports 228. In some embodiments, a wide L-shaped sloped or ramped channel 242 may supply one or more of the outer vent ports 228. In some embodiments, a wide straight-shaped sloped or ramped channel 244 may supply one or more of the outer vent port 228. The ramp features described herein may be useful for removing bubbles or air that may be present in the critical sensor and mixing areas.

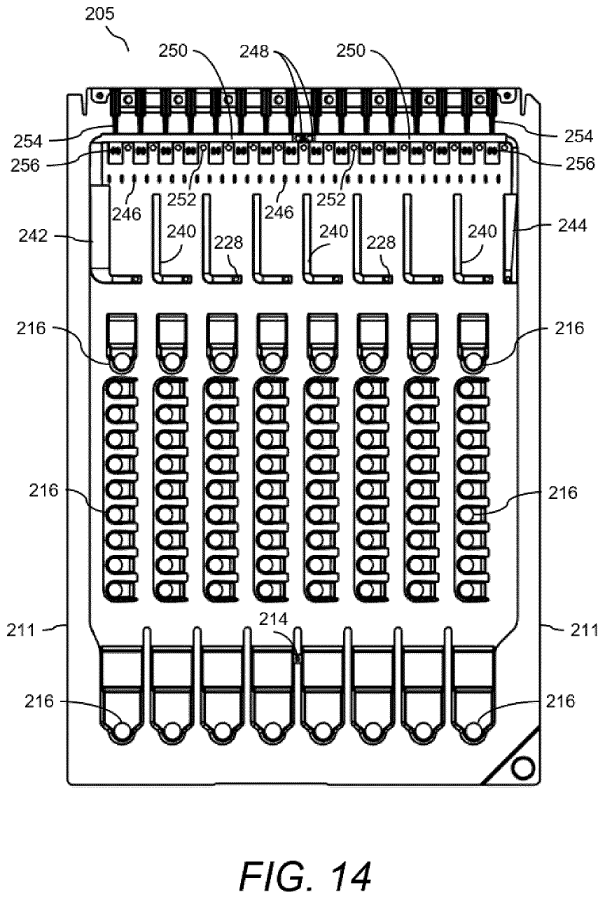

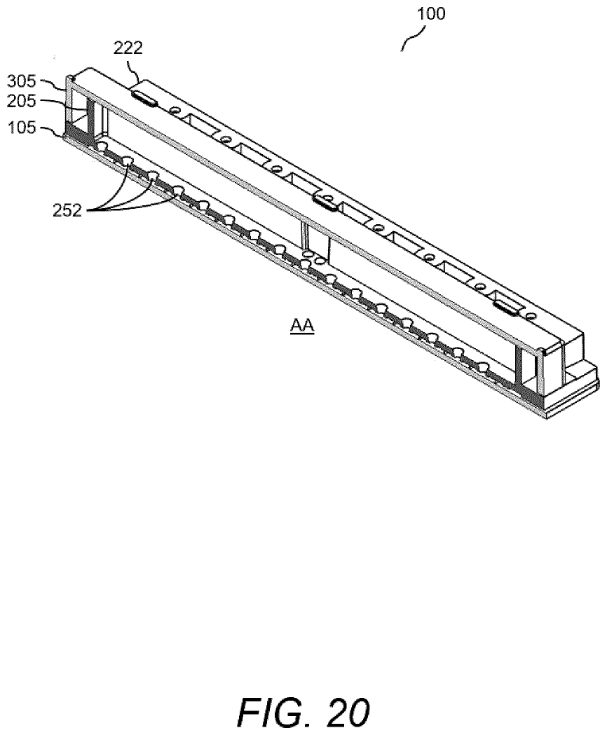

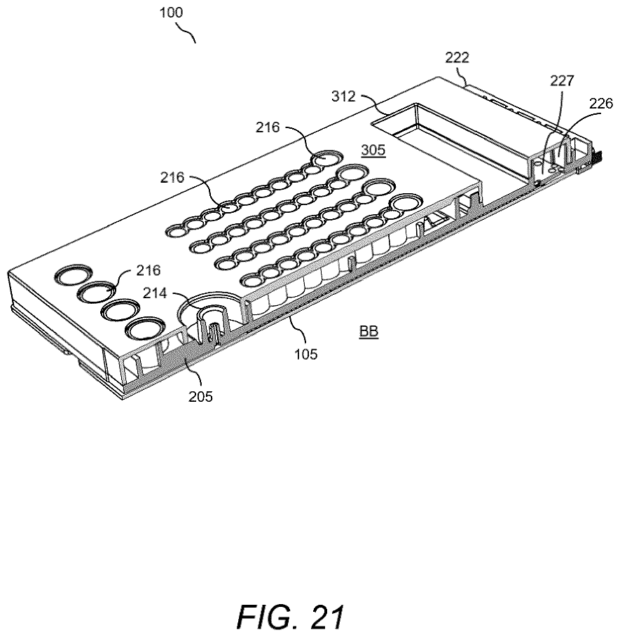

Additionally, in some embodiments, top substrate 205 may include a plurality of small-slot vent ports 246 and a pair of vent ports 248 in or near the waste-port region 226. In some embodiments, a sloped or ramped channel 250 may supply each of the vent ports 248. Additionally, in some embodiments, waste-port region 226 may include multiple waste ports 252 (e.g., see FIG. 20). Further, to support optical fiber assembly 122, which may include optical fibers 126, the underside of top substrate 205 may comprise slots or channels 254 and guide features 256 for receiving optical fibers 126 (e.g., see FIG. 14). Again, all arranged as shown, for example, in FIG. 1A through FIG. 3.

In microfluidics device 100, the cover plate 305 may include an outer wall 310, an optical viewing window 312, an arrangement of openings 320 (e.g., multiple rows or columns of openings 320, individual openings 320, and the like), an additional opening 322, and alignment features 328 (e.g., see FIG. 18). All arranged as shown, for example, in FIG. 1A through FIG. 3.

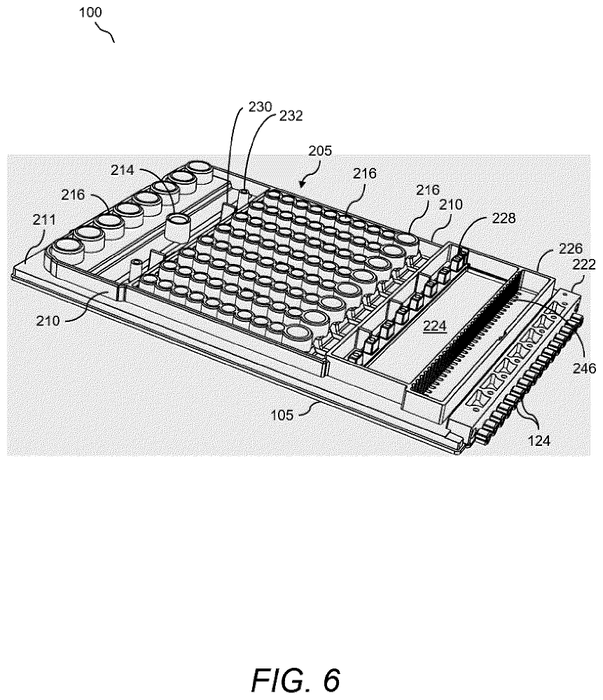

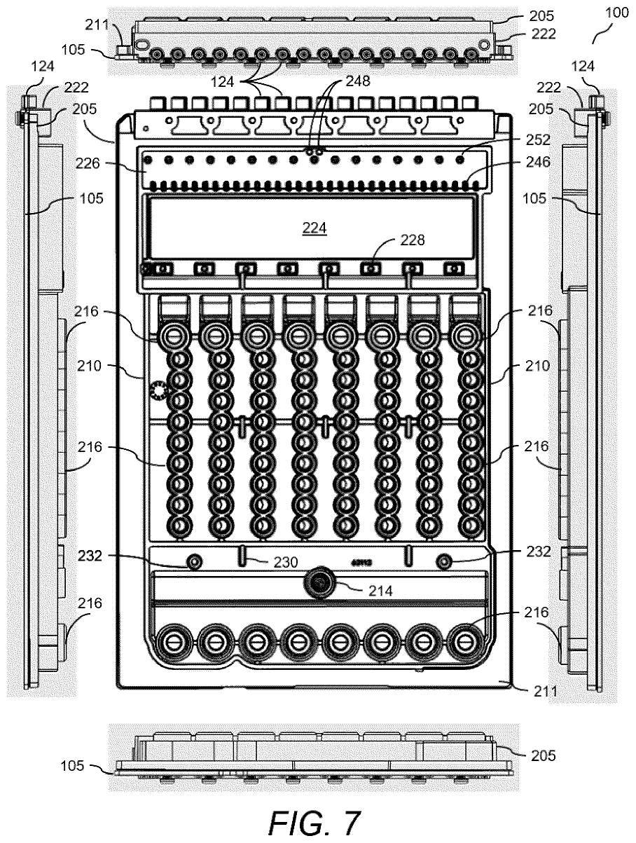

To show more details of top substrate 205 in relation to bottom substrate 105, FIG. 6 is an isometric top view of the microfluidics device 100 shown in FIG. 1A and FIG. 1B, but absent the cover plate 305. Further, FIG. 7 shows a top view, a first side view, a second side view, a first end view, and a second end view of the microfluidics device 100 shown in FIG. 1A and FIG. 1B, but absent the cover plate 305.

Referring to FIG. 1A through FIG. 7, in some embodiments, the presently disclosed microfluidics device 100 may include other functions, elements, and/or components (not shown) that may be in, on, and/or between the top substrate 205 and the cover plate 305. For example, these other functions, elements, and/or components may include, but are not limited to, optical elements, electronics, magnetics, and the like. Inclusion of these other functions, elements, and/or components in a gap below the cover plate 305 but above the top substrate 205 (e.g., between the cover plate 305 and top plate 205) may provide for protection of these other functions, elements, and/or components from user damage (e.g., where a user spills aqueous reagents on the device while pipetting samples into the device), physical shocks, electrostatic discharge, or other interferences. Inclusion of one or more sensors in the gap below the cover plate 305 but above the top substrate 205 may provide an additional method of protecting these other functions, elements, and/or components.

Additionally, FIG. 8A, FIG. 8B, and FIG. 9 are top views showing an example of bonding between bottom substrate 105 and top substrate 205 of the presently disclosed microfluidics device 100 shown in FIG. 1A and FIG. 1B. For example, FIG. 8A shows a potential bond line 150 in relation to bottom substrate 105. Similarly, FIG. 8A shows the potential bond line 150 in relation to top substrate 205. In some embodiments, the potential bond line 150 may fall within an edge region 211 of top substrate 205, which may be clear of physical obstacles in the absence of cover plate 305. In some embodiments, the bottom substrate 105 and the top substrate 205 may be bonded together by, for example, a friction fit, an adhesive bond, a snap-fit, fasteners, or any combinations thereof. Accordingly, FIG. 9 shows an example of the bottom substrate 105 and the top substrate 205 bonded together. FIG. 9 also shows that, absent the cover plate 305, there may be an obstacle-free optical view of bond line 150. This obstacle-free optical view may allow the bonding process to be observed visually (e.g., manually and/or automatically) by a user during and/or after a bonding process, which may ensure a highly reliable bond that is not prone to leakage and that may be visually monitored continually (e.g., in an ongoing fashion).

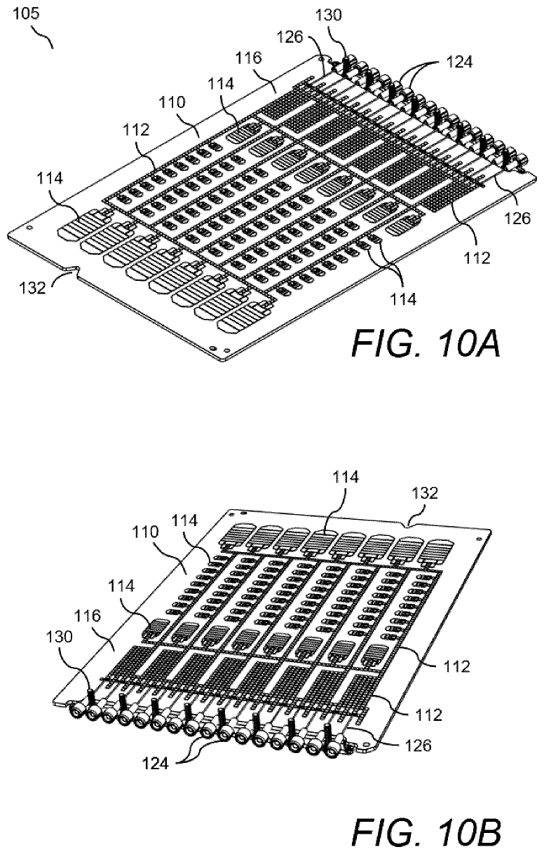

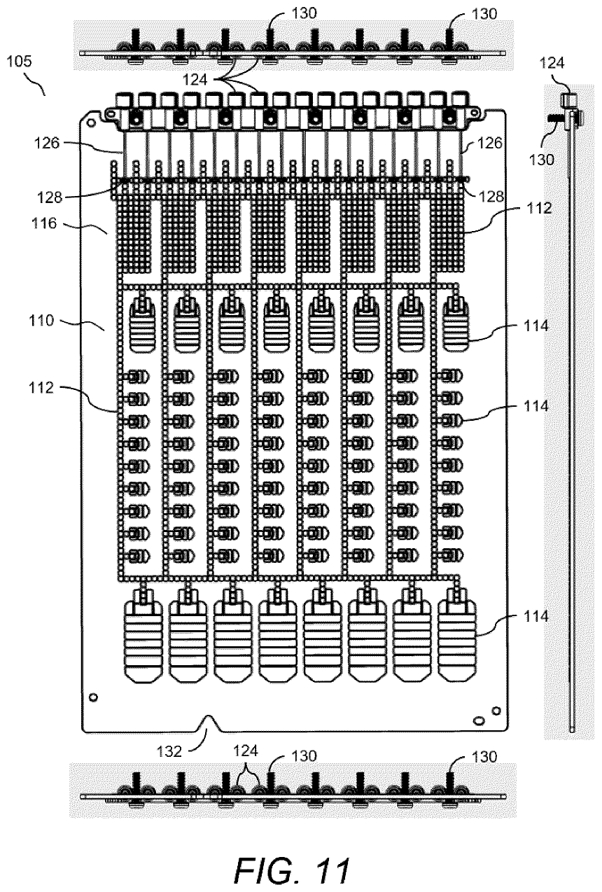

Referring now to FIG. 10A and FIG. 10B are isometric views of an example of the bottom substrate 105 of the presently disclosed microfluidics device 100 shown in FIG. 1A and FIG. 1B. Further, FIG. 11 shows a top view, a side view, a first end view, and a second end view of the bottom substrate 105 shown in FIG. 10A and FIG. 10B. A bottom view of the bottom substrate 105 is essentially shown in FIG. 5.

In one example, not including holding ferrules 124, bottom substrate 105 may comprise certain dimensions (e.g., a length, a width, and a thickness). In some embodiments, bottom substrate 105 may have a length of 40 mm (millimeters) or more, 50 mm or more, 60 mm or more, 70 mm or more, 80 mm or more, 90 mm or more, 100 mm or more, 110 mm or more, 120 mm or more, 130 mm or more, 140 mm or more, 150 mm or more, 160 mm or more, 170 mm or more, 180 mm or more, 190 mm or more, or 200 mm or more. In some embodiments, bottom substrate 105 may have a length of 200 mm or less, 190 mm or less, 180 mm or less, 170 mm or less, 160 mm or less, 150 mm or less, 140 mm or less, 130 mm or less, 120 mm or less, 110 mm or less, 100 mm or less, 90 mm or less, 80 mm or less, 70 mm or less, 60 mm or less, 50 mm or less, or 40 mm or less. In some embodiments, bottom substrate 105 may have a width of 40 mm or more, 50 mm or more, 60 mm or more, 70 mm or more, 80 mm or more, 90 mm or more, 100 mm or more, 110 mm or more, 120 mm or more, 130 mm or more, 140 mm or more, 150 mm or more, 160 mm or more, 170 mm or more, 180 mm or more, 190 mm or more, or 200 mm or more. In some embodiments, bottom substrate 105 may have a width of 200 mm or less, 190 mm or less 180 mm or less, 170 mm or less, 160 mm or less, 150 mm or less, 140 mm or less, 130 mm or less, 120 mm or less, 110 mm or less, 100 mm or less, 90 mm or less, 80 mm or less, 70 mm or less, 60 mm or less, 50 mm or less, or 40 mm or less. In some embodiments, bottom substrate 105 may have a thickness of 0.1 mm or more, 0.2 mm or more, 0.3 mm or more, 0.4 mm or more, 0.5 mm or more, 0.6 mm or more, 0.7 mm or more, 0.8 mm or more, 0.9 mm or more, 1 mm or more, 1.1 mm or more, 1.2 mm or more, 1.3 mm or more, 1.4 mm or more, 1.5 mm or more, 1.6 mm or more, 1.7 mm or more, 1.8 mm or more, 1.9 mm or more, or 2.0 mm or more. In some embodiments, bottom substrate 105 may have a thickness of 2.0 mm or less, 1.9 mm or less, 1.8 mm or less, 1.7 mm or less, 1.6 mm or less, 1.5 mm or less, 1.4 mm or less, 1.3 mm or less, 1.2 mm or less, 1.1 mm or less, 1 mm or less, 0.9 mm or less, 0.8 mm or less, 0.7 mm or less, 0.6 mm or less, 0.5 mm or less, 0.4 mm or less, 0.3 mm or less, 0.2 mm or less, or 0.1 mm or less. In one example, the dimensions (e.g., height, width, thickness) of bottom substrate 105 may be the same or substantially similar to the dimensions of a standard microwell plate. For example, the dimension of bottom substrate 105 may be the same or substantially similar to a standard 96-well plate, a standard 48-well plate, a standard 12-well plate, or a standard 4-well plate. In another example, the dimensions (e.g., height, width, thickness) of bottom substrate 105 may not be the same or substantially similar to the dimensions of a standard microwell plate. In some embodiments, bottom substrate 105 may comprise a length of about 125 mm, a width of about 85 mm, and a thickness of about 1 mm. In some embodiments, bottom substrate 105 may comprise a length of about 129 mm, a width of about 85 mm, and a thickness of about 4 mm. Accordingly, microfluidics device 100 may be designed to fit into existing microwell plate handling systems.

In some embodiments, the bottom substrate 105 may include an electrode arrangement 110. In some embodiments, the electrode arrangement 110 may include droplet operations electrodes 112 (e.g., electrowetting electrodes), reservoir electrodes 114, a mixing region 116 formed of arrays of droplet operations electrodes 112, and an optical fiber assembly 122. In some embodiments, the optical fiber assembly 122 may include sixteen holding ferrules 124 and optical fibers 126 with sensors 128. In some embodiments, the optical fiber assembly 112 comprises more or less than sixteen holding ferrules 124. Additionally, in some embodiments, the bottom substrate 105 may have an alignment notch 132.

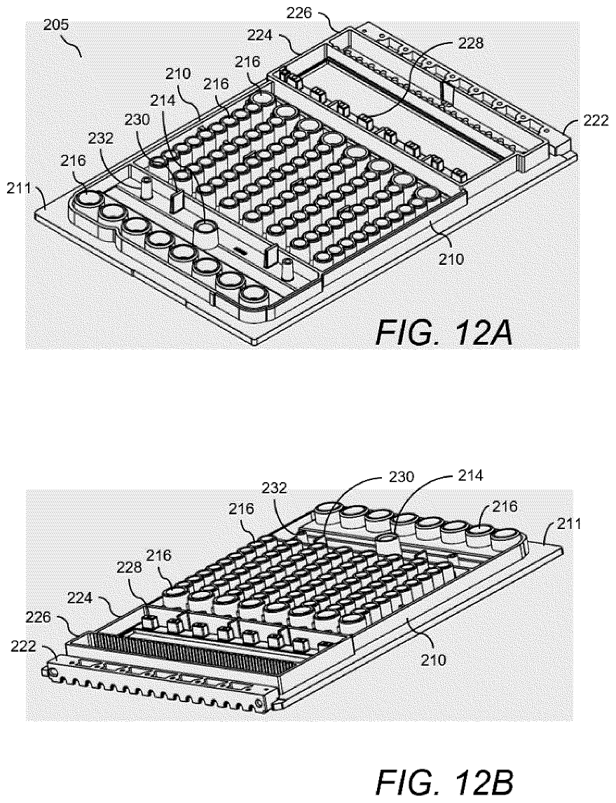

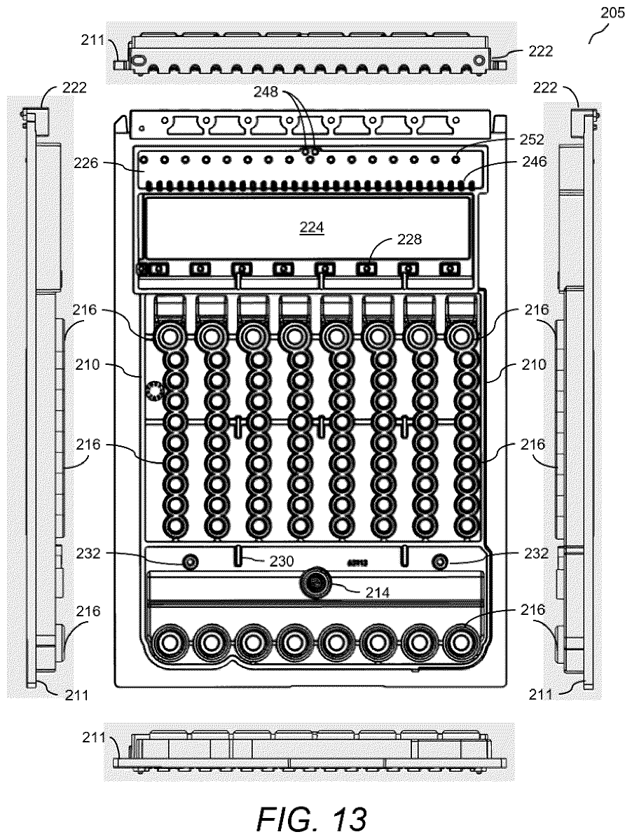

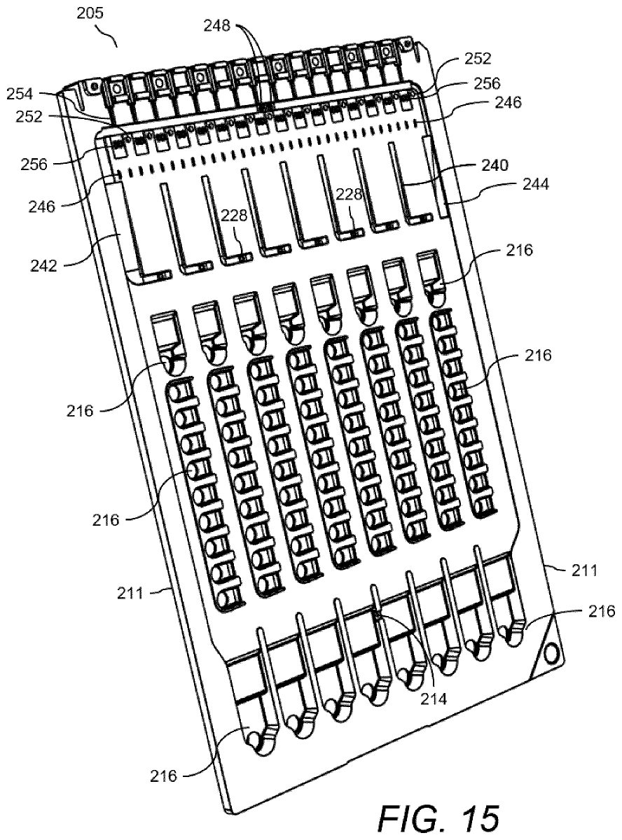

Referring now to FIG. 12A and FIG. 12B are isometric views of an example of the top substrate 205 of the presently disclosed microfluidics device 100 shown in FIG. 1A and FIG. 1B. Further, FIG. 13 shows a top view, a first side view, a second side view, a first end view, and a second end view of the top substrate 205 shown in FIG. 12A and FIG. 12B. Further, FIG. 14 and FIG. 15 show a bottom view and a bottom isometric view, respectively, of the top substrate 205 shown in FIG. 12A and FIG. 12B.

In one example, top substrate 205 may comprise dimensions (e.g., a length, a width, and a thickness). In some embodiments, the top substrate 205 may have a length of 40 mm (millimeters) or more, 50 mm or more, 60 mm or more, 70 mm or more, 80 mm or more, 90 mm or more, 100 mm or more, 110 mm or more, 120 mm or more, 130 mm or more, 140 mm or more, 150 mm or more, 160 mm or more, 170 mm or more, 180 mm or more, 190 mm or more, or 200 mm or more. In some embodiments, top substrate 205 may have a length of 200 mm or less, 190 mm or less, 180 mm or less, 170 mm or less, 160 mm or less, 150 mm or less, 140 mm or less, 130 mm or less, 120 mm or less, 110 mm or less, 100 mm or less, 90 mm or less, 80 mm or less, 70 mm or less, 60 mm or less, 50 mm or less, or 40 mm or less. In some embodiments, the top substrate 205 may have a width of 40 mm or more, 50 mm or more, 60 mm or more, 70 mm or more, 80 mm or more, 90 mm or more, 100 mm or more, 110 mm or more, 120 mm or more, 130 mm or more, 140 mm or more, 150 mm or more, 160 mm or more, 170 mm or more, 180 mm or more, 190 mm or more, or 200 mm or more. In some embodiments, top substrate 205 may have a width of 200 mm or less, 190 mm or less 180 mm or less, 170 mm or less, 160 mm or less, 150 mm or less, 140 mm or less, 130 mm or less, 120 mm or less, 110 mm or less, 100 mm or less, 90 mm or less, 80 mm or less, 70 mm or less, 60 mm or less, 50 mm or less, or 40 mm or less. In some embodiments, the top substrate 205 may have a thickness of 0.1 mm or more, 0.2 mm or more, 0.3 mm or more, 0.4 mm or more, 0.5 mm or more, 0.6 mm or more, 0.7 mm or more, 0.8 mm or more, 0.9 mm or more, 1 mm or more, 1.1 mm or more, 1.2 mm or more, 1.3 mm or more, 1.4 mm or more, 1.5 mm or more, 1.6 mm or more, 1.7 mm or more, 1.8 mm or more, 1.9 mm or more, or 2.0 mm or more. In some embodiments, the top substrate 205 may have a thickness of 2.0 mm or less, 1.9 mm or less, 1.8 mm or less, 1.7 mm or less, 1.6 mm or less, 1.5 mm or less, 1.4 mm or less, 1.3 mm or less, 1.2 mm or less, 1.1 mm or less, 1 mm or less, 0.9 mm or less, 0.8 mm or less, 0.7 mm or less, 0.6 mm or less, 0.5 mm or less, 0.4 mm or less, 0.3 mm or less, 0.2 mm or less, or 0.1 mm or less. In one example, the dimensions (e.g., height, width, thickness) of the top substrate 205 may be the same or substantially similar to the dimensions of a standard microwell plate. For example, the dimension of top substrate 205 may be the same or substantially similar to a standard 96-well plate, a standard 48-well plate, a standard 12-well plate, or a standard 4-well plate. In another example, the dimensions (e.g., height, width, thickness) of the top substrate 205 may not be the same or substantially similar to the dimensions of a standard microwell plate. In some embodiments, the top substrate 205 may comprise a length of about 125 mm, a width of about 85 mm, and a thickness of about 9 mm. In some embodiments, top substrate 205 may comprise a length of about 129 mm, a width of about 85 mm, and a thickness of about 13 mm.

Again, in some embodiments, the top substrate 205 may include an inner wall 210 in relation to an edge region 211, a fluid port 214, an arrangement of wells 216 (e.g., multiple rows or columns of wells 216, individual wells 216, and the like), a fiber optic connector 222, an optical detection region 224, a waste-port region 226 that may include waste ports 252 (e.g., see FIG. 20), a plurality of vent ports 228, multiple height-setting features (HSFs) 230, and standoffs 232. In some embodiments, the inner wall 210 of the top substrate 205 may provide structure and strength. Further, in some embodiments, and in the case of oil leaks, the inner wall 210 of the top substrate 205 may help contain oil in the device.

Additionally, the top substrate 205 may include a plurality of vent ports 228 supplied by L-shaped sloped or ramped channels 240, a plurality of vent ports 228 supplied by wide L-shaped sloped or ramped channel 242, and a plurality of vent ports 228 supplied by wide straight-shaped sloped or ramped channel 244. Additionally, in some embodiments, the top substrate 205 may include a plurality of small-slot vent ports 246 and may also include the two vent ports 248 that may be supplied by sloped or ramped channel 250.

Further, the presence of the plurality of vent ports 228 of the top substrate 205, the plurality of small-slot vent ports 246 at waste-port region 226 of top substrate 205, and the two vent ports 248 at one end of top substrate 205 may provide ample opportunities for air and/or air bubbles to escape the oil environment of the microfluidics device 100. That is, in some embodiments, the plurality of vent ports 228, the plurality of small-slot vent ports 246, and the two vent ports 248 may be sized and/or positioned locally to areas where droplet operations occur or in areas where heat is localized to allow air and/or air bubbles to escape the oil environment of microfluidics device 100. Further, in some embodiments, where the plurality of vent ports 228 are open to air, the cover plate 305 may cover for the vent ports 228, while still allowing the plurality of vent ports 228 to vent air. Thus, the microfluidics device 100 may provide for increased venting capacity.

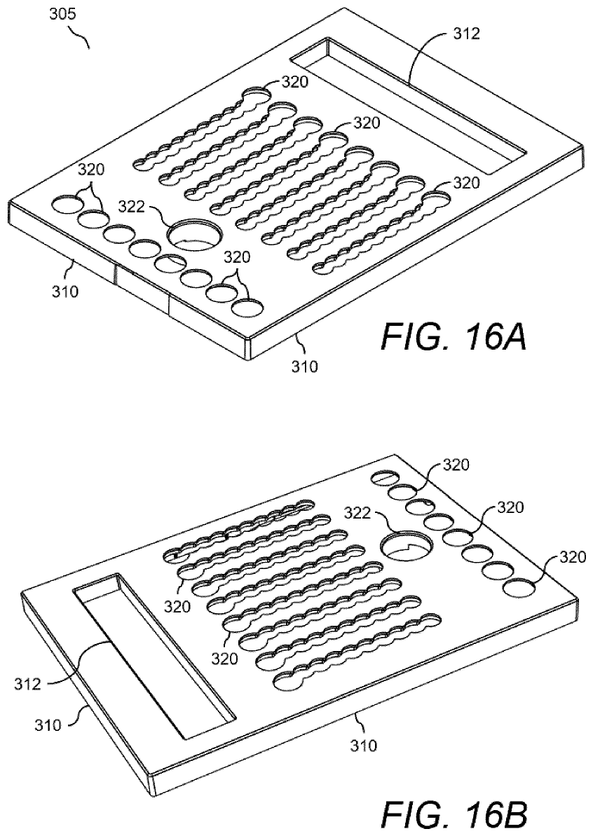

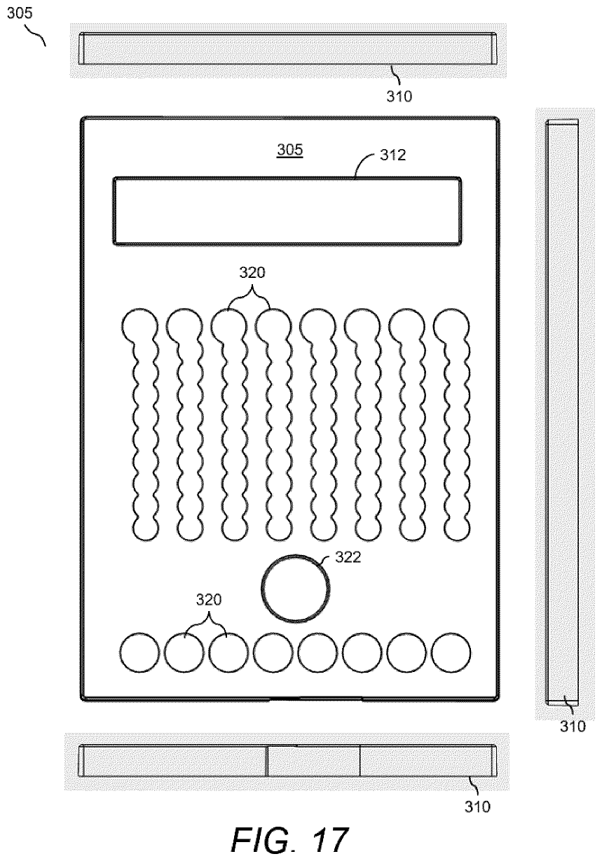

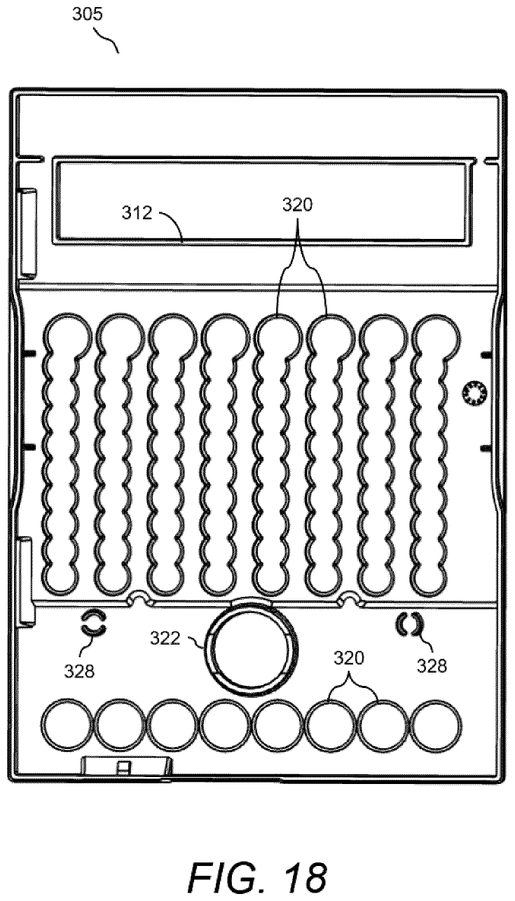

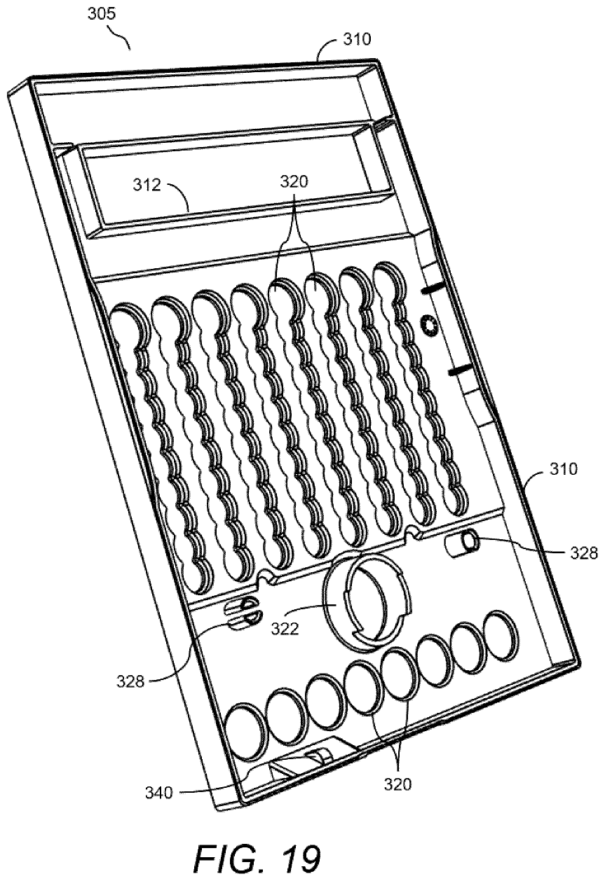

Referring now to FIG. 16A and FIG. 16B are isometric views of an example of cover plate 305 of the presently disclosed microfluidics device 100 shown in FIG. 1A and FIG. 1B. Further, FIG. 17 shows a top view, a first side view, a second side view, a first end view, and a second end view of the cover plate 305 shown in FIG. 16A and FIG. 16B. Further, FIG. 18 and FIG. 19 show a bottom view and a bottom isometric view, respectively, of the cover plate 305 shown in FIG. 16A and FIG. 16B.

In some embodiments, the cover plate 305 may comprise dimensions (e.g., a length, a width, and a thickness). In some embodiments, the cover plate 305 may have a length of 40 mm (millimeters) or more, 50 mm or more, 60 mm or more, 70 mm or more, 80 mm or more, 90 mm or more, 100 mm or more, 110 mm or more, 120 mm or more, 130 mm or more, 140 mm or more, 150 mm or more, 160 mm or more, 170 mm or more, 180 mm or more, 190 mm or more, or 200 mm or more. In some embodiments, cover plate 305 may have a length of 200 mm or less, 190 mm or less, 180 mm or less, 170 mm or less, 160 mm or less, 150 mm or less, 140 mm or less, 130 mm or less, 120 mm or less, 110 mm or less, 100 mm or less, 90 mm or less, 80 mm or less, 70 mm or less, 60 mm or less, 50 mm or less, or 40 mm or less. In some embodiments, the cover plate 305 may have a width of 40 mm or more, 50 mm or more, 60 mm or more, 70 mm or more, 80 mm or more, 90 mm or more, 100 mm or more, 110 mm or more, 120 mm or more, 130 mm or more, 140 mm or more, 150 mm or more, 160 mm or more, 170 mm or more, 180 mm or more, 190 mm or more, or 200 mm or more. In some embodiments, cover plate 305 may have a width of 200 mm or less, 190 mm or less 180 mm or less, 170 mm or less, 160 mm or less, 150 mm or less, 140 mm or less, 130 mm or less, 120 mm or less, 110 mm or less, 100 mm or less, 90 mm or less, 80 mm or less, 70 mm or less, 60 mm or less, 50 mm or less, or 40 mm or less. In some embodiments, the cover plate 305 may have a thickness of 0.1 mm or more, 0.2 mm or more, 0.3 mm or more, 0.4 mm or more, 0.5 mm or more, 0.6 mm or more, 0.7 mm or more, 0.8 mm or more, 0.9 mm or more, 1 mm or more, 1.1 mm or more, 1.2 mm or more, 1.3 mm or more, 1.4 mm or more, 1.5 mm or more, 1.6 mm or more, 1.7 mm or more, 1.8 mm or more, 1.9 mm or more, or 2.0 mm or more. In some embodiments, the cover plate 305 may have a thickness of 2.0 mm or less, 1.9 mm or less, 1.8 mm or less, 1.7 mm or less, 1.6 mm or less, 1.5 mm or less, 1.4 mm or less, 1.3 mm or less, 1.2 mm or less, 1.1 mm or less, 1 mm or less, 0.9 mm or less, 0.8 mm or less, 0.7 mm or less, 0.6 mm or less, 0.5 mm or less, 0.4 mm or less, 0.3 mm or less, 0.2 mm or less, or 0.1 mm or less. In one example, the dimensions (e.g., height, width, thickness) of the cover plate 305 may be the same or substantially similar to the dimensions of a standard microwell plate. For example, the dimension of cover plate 305 may be the same or substantially similar to a standard 96-well plate, a standard 48-well plate, a standard 12-well plate, or a standard 4-well plate. In another example, the dimensions (e.g., height, width, thickness) of the cover plate 305 may not be the same or substantially similar to the dimensions of a standard microwell plate. In some embodiments, the cover plate 305 may comprise a length of about 120 mm, a width of about 85 mm, and a thickness of about 7 mm. In some embodiments, the cover plate 305 may comprise a length of about 125 mm, a width of about 85 mm, and a thickness of about 5 mm.

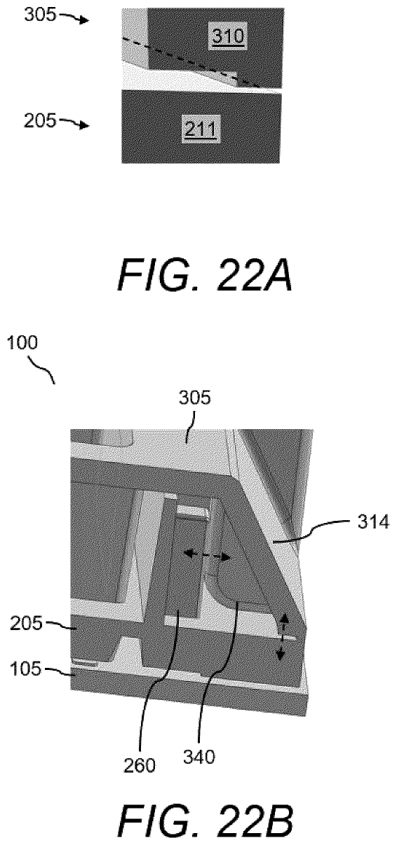

Again, the cover plate 305 may include an outer wall 310, an optical viewing window 312, a plurality of openings 320 (e.g., multiple rows or columns of openings 320, individual openings 320, and the like), an additional opening 322, and alignment features 328 (e.g., see FIG. 18 and FIG. 19). Additionally, FIG. 19 shows that the cover plate 305 may include one or more L-alignment features 340. More details of L-alignment feature 340 are shown hereinbelow, for example, in FIG. 22B.

Another aspect of the cover plate 305 may be that optical viewing window 312 may provide a large oil-protected viewing window for a user. For example, the walls of optical viewing window 312 may be sealed (e.g., via adhesive) against the outer surface of top substrate 205. Additionally, in some embodiments, the walls of the optical viewing window 312 may provide protection against, for example, air leaking in or oil leaking out. In some embodiments, the walls of the optical viewing window 312 may be configured to minimize any interaction with a surrounding environment.

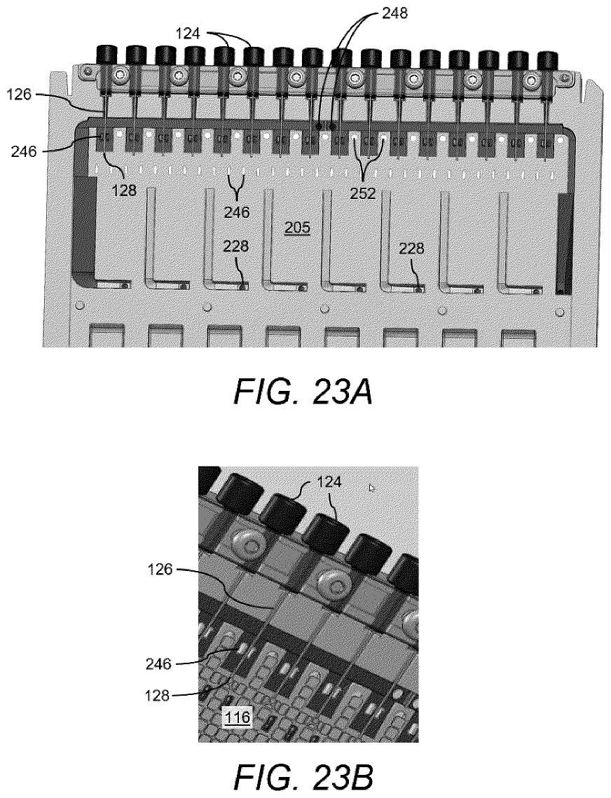

When assembled, in some embodiments, mixing region 116 of bottom substrate 105, optical detection region 224 of the top substrate 205, and the optical viewing window 312 of the cover plate 305 may be substantially aligned. Accordingly, in some embodiments, the optical viewing window 312 of the cover plate 305 and the optical detection region 224 of the top substrate 205 may provide optical access to the mixing region 116 of the bottom substrate 105. This optical access may be useful for a user conducting optical detection operations. This optical access may also be useful for a user to monitor visually the droplet operations. Further, the optical fibers 126 with sensors 128 may extend into the mixing region 116 of the bottom substrate 105 (e.g., see FIG. 23B).

Further, in microfluidics device 100, the cover plate 305 may be installed and dispose over the top substrate 205 by, for example, a friction fit, an adhesive bond, a snap-fit, fasteners, or any combinations thereof.

For example, FIG. 20 is a cross-sectional view taken along line A-A of FIG. 4 and shows details of the waste ports 252-portion of microfluidics device 100. The waste ports 252 of the top substrate 205 may be cone-shaped (e.g., opening upward). In some embodiments, the one or more waste ports may be cone-shaped. In some embodiments, the cone-shaped waste ports may have an upward opening (e.g., at the nadir of the cone) configured to hold fluid. In some embodiments, the fluid held in the cone-shaped waste ports may flow out of the cone-shaped waste ports and into the waste port region. The shape of the waste ports may be favorable to pull droplets up into waste ports 252 against gravity. For example, droplets may be flat when transported, but then may expand when arriving at a waste port 252 and then may move upward through the cone-shaped waste ports 252. In some embodiments, once a droplet is present in the waste port 252, the cone-shape of the waste port may help to hold the droplet within the waste port 252 against gravity. Additionally, in some embodiments, liquid may flow out of the waste port 252 and into a waste-port region 226. In some embodiments, the waste-port region 226 can hold waste liquid in bulk, for example, see FIG. 21.

Further, FIG. 21 is a cross-sectional view taken along line B-B of FIG. 4 and shows a full-length cross-section that shows more details of microfluidics device 100. Referring now again to the waste ports 252-portion of microfluidics device 100, in some embodiments, any droplets spilling out of any waste port 252 may fall into the waste-port region 226. In some embodiments, waste-port region may comprise a sloped floor 227 by which liquid may move away from any waste port 252 and collect in the waste-port region 226.

Referring now to FIG. 22A through FIG. 23B are certain views of various portions of the presently disclosed microfluidics device 100 shown in FIG. 1A and FIG. 1B and shows certain features thereof. For example, in some embodiments, the outer edge of the cover plate 305 may be adhered (e.g., using an adhesive not shown) to the top substrate 205, as shown in FIG. 22A. An outer lip of the cover plate 305 may be used to transmit force from the cover plate 305 to the top substrate 205.

Further, in some embodiments, features of cover plate 305 may be provided for transferring x, y, z forces present in the cover plate 305 to the top substrate 205, as shown in FIG. 22B. For example, in some embodiments, the cover plate 305 may include an L-alignment feature 340. In some embodiments, the L-alignment feature 340 may be used to press against an alignment feature 260 of the top substrate 205, which, at the same time, may press against the surface of top substrate 205. In this way, both horizontal and vertical forces may be transferred from the cover plate 305 to the top substrate 205. In some embodiments, the L-alignment feature 340 may be configured to align the top substrate 205 and with cover plate 305.

FIG. 23A shows more details of the waste-port region 226 of microfluidics device 100 and shows the two vent ports 248. Further, FIG. 23B shows more details of the holding ferrules 124 and optical fibers 126 with sensors 128.

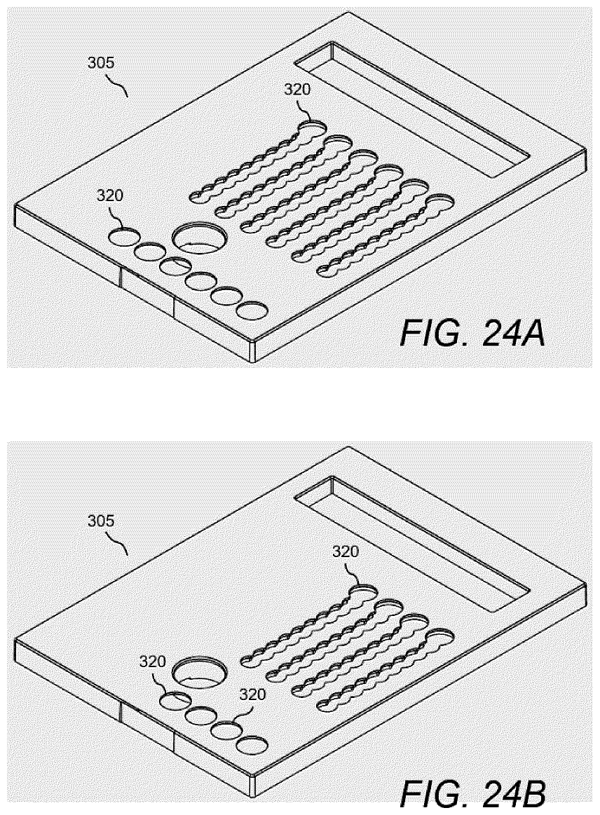

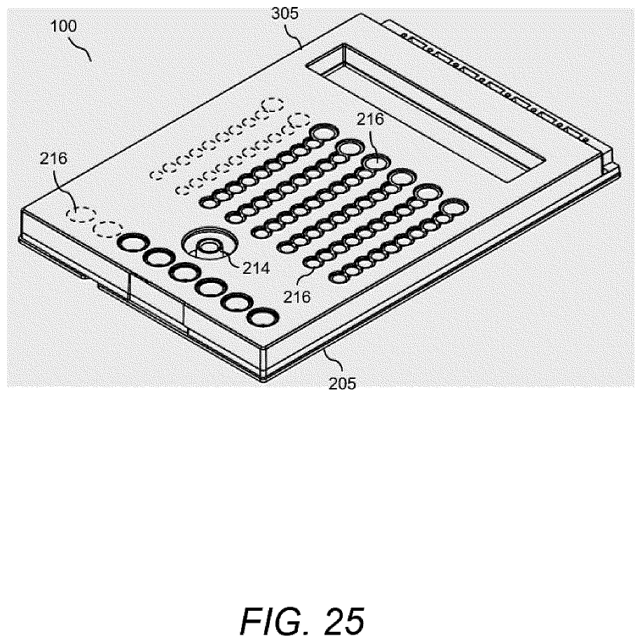

In some embodiments, the presently disclosed microfluidics device 100 may provide a cover plate comprising a design that may be customized to expose one or more wells (or reservoirs) 216 of top substrate 205 and/or may serve as a physical barrier to block or cover one or more wells 216 of top substrate 205. For example, FIG. 24A, FIG. 24B, and FIG. 25 are isometric views showing non-limiting examples of cover plates 305 of the presently disclosed microfluidics device 100 shown in FIG. 1A and FIG. 1B. In some embodiments, the cover plate 305 may be opaque such as to obscure a user's vision of the underlying top substrate 205 or bottom substrate 105. In some embodiments, where the cover plate 305 is substantially opaque, one or more features (e.g., one or more wells (or reservoirs) of the top substrate 205) may be visually obscured from a user. In some embodiments, where the cover plate 305 is substantially opaque, photo sensitive reagents present in the device may be protected from light. In some embodiments, the cover plate 305 may be substantially transparent to light. In some embodiments, where the cover plate 305 is substantially transparent to light, a user may visually inspect fluidic movement in the device. In some embodiments, where the cover plate 305 is substantially transparent to light, a user may visually inspect droplet size movement and operations, which may provide for better error detection/measurement of errors.

In one example, instead of the cover plate 305 including eight columns of openings 320 (e.g., see FIG. 16A and FIG. 16B), the cover plate 305 may include a lesser number of columns of openings 320. For example, FIG. 24A shows an example of the cover plate 305 including six columns of openings 320. Further, FIG. 24B shows an example of the cover plate 305 including four columns of openings 320. In some embodiments, the cover plate 305 may comprise more or less than four columns of openings. FIG. 25 shows an example of the 6-column cover plate 305 disposed over the top substrate 205. In this example, the 6-column cover plate 305 may change the 16-channel microfluidics device 100 to a 12-channel microfluidics device 100 without the need to change the (more complex) top substrate 205.

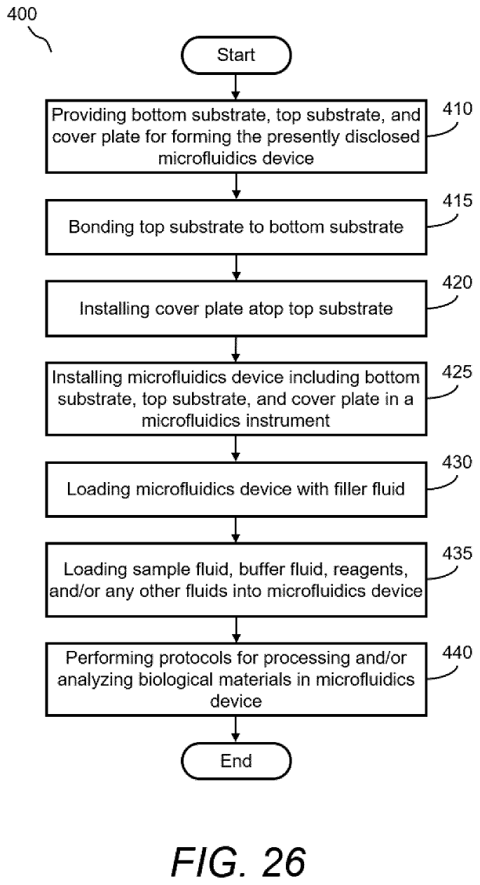

Referring now again to FIG. 1A through FIG. 25, in some embodiments, the inventive concepts described herein may also be directed to a method of using the presently disclosed microfluidics device 100 that includes bottom substrate 105, top substrate 205, and cover plate 305. For example, FIG. 26 is a flow diagram of a non-limiting example of a method 400 of using microfluidics device 100. Method 400 may include, but is not limited to, the following steps.

At a step 410, a bottom substrate, a top substrate, and a cover plate are provided for forming a microfluidics device in accordance with the present inventive concepts. For example, the bottom substrate 105, the top substrate 205, and the cover plate 305 may be provided for forming microfluidics device 100, as described hereinabove with reference to FIG. 1A through FIG. 25.

At a step 415, the top substrate 205 may be bonded to the bottom substrate 105. For example, the top substrate 205 may be bonded (e.g., via adhesive) to the bottom substrate 105, as shown, for example, in FIG. 8A, FIG. 8B, and FIG. 9.

At a step 420, the cover plate 305 may be disposed over the top substrate 205. For example, the cover plate 305 may be installed over the top substrate 205. In one example, the cover plate 305 may be disposed over the top substrate 205 by, for example, a friction fit, an adhesive bond, a snap-fit, fasteners, or any combinations thereof.

At a step 425, the microfluidics device 100 that includes the bottom substrate 105, the top substrate 205, and the cover plate 305 may be installed in a microfluidics instrument. For example, the microfluidics device 100 that includes the bottom substrate 105, the top substrate 205, and the cover plate 305 may be installed in a microfluidics instrument (not shown).

At a step 430, filler fluid may be loaded into the microfluidics device. In one example, filler fluid may be loaded into microfluidics device 100 through fluid port 214.

At a step 435, sample fluid, buffer fluid, reagents, and/or any other fluids may be loaded into the microfluidics device. For example, sample fluid, buffer fluid, reagents, and/or any other fluids may be loaded into the wells 216 of microfluidics device 100.

At a step 440, protocols for processing and/or analyzing biological materials may be performed in the microfluidics device. For example, protocols for processing and/or analyzing biological materials may be performed in the microfluidics device 100.

One problem that existing microfluidics devices have is the need for a top substrate with features that require a high degree of manufacturing precision (e.g., +/−25 um or better).

By contrast, the presently disclosed microfluidics device may comprise a cover plate configured to integrate features typically found on existing top substrates. For example, the cover plate may be configured to contain an outer wall. As such, the presently disclosed microfluidics device may comprise a cover plate with features found on existing top substrates, thereby reducing the number of features needed for the top substrate and reducing the number of difficulties and complications that may come with manufacturing the top substrate

Another problem that existing microfluidics devices have is a lack of versatility/adaptability. For example, in existing microfluidics devices, any change to cartridge throughput (e.g., the number of samples, reagent inlets, or analysis zones) may requires a change in the design of the top substrate, which may requires expensive and complex changes to the injection molding process of the top substrate. One consequence of altering the top substrate is a greater risk of poor performance.

By contrast, the presently disclosed microfluidics device may comprise a cover plate configured to expose and/or cover one or more wells (or reservoirs) or inlets or outlets present on the top substrate. As such, in some embodiments, the cover plate may be configured to artificially alter the cartridge throughput (e.g., the number of samples, reagent inlets, or analysis zones) without the need to change the design or injection molding process of the top substrate.

Further, the cover plate as described herein may reduce the risk that a user erroneously introduces samples and/or reagents in a wrong location of the microfluidics device.

In some embodiments, the cover plate may comprise a substantially flat surface suitable for cover plate labels or cover plate stickers. The cover plate labels or cover plate stickers may further guide a user or guide any machine vision driven error detection mechanisms. Further, the cover plate labels or cover plate stickers may be used to expose and/or cover one or more wells of the top substrate or the cover plate. As such, the number of wells may be modified without the need to change the design or the top substrate or the cover plate.

An additional problem that existing microfluidics devices have is evaporation of droplets and/or filler fluid. Existing digital microfluidics devices may comprise a large surface area in the gap between the top and bottom substrates. The large surface area may lead to droplet and/or filler fluid evaporation. For example, bio-analytical techniques that may require high temperatures (e.g., certain types of immunoassays and nucleic acid amplification procedures) may cause the fluid, the sample, and/or the reagents to evaporate quickly.

One solution to evaporation is through the use of a silicone oil-based filler fluid. However, silicone oil-based filler fluid may contain low surface tension, which may fail to meet the interfacial tension specifications required for aqueous droplet formation and transport. As such, filler fluid may also evaporate through well inlets/openings, and the waste trough during the course of assay protocols.

By contrast, the presently disclosed microfluidics device may comprise a cover plate configured to reduce evaporation of droplets and/or filler fluid. In some embodiments, the cover plate may cover portions of the microfluidics device to reduce evaporation of droplets and/or filler fluid. For example, the cover plate may cover a waste trough, which may be the largest exposed area from which filler fluid can evaporate. Covering the waste trough may allow a user to perform kinetics assays at a desired temperature (e.g., 37 C or higher). In some embodiments, the cover plate may introduce an air gap between the top substrate and the cover plate. The air gap may thermally insulate the microfluidics device and may provide for more efficient heating.

An additional problem that existing microfluidics devices have is uneven compression throughout the device. Providing even compression throughout the microfluidics device ensures that gap sizes between the top and bottom substrates remain consistent across the device. For example, electrodes in existing digital microfluidics substrates are connected to the control electronics in the digital microfluidics instrument via a pogo-pin interface that lines up with an array of contact pads located on the substrates. To ensure good contact with the pogo pins, the digital microfluidics cartridge should be compressed with, for example, a compression plate.

Existing microfluidics devices comprise a top substrate with features (e.g., compression features, ramps, ribs, and well inlets). The features of the top substrate in existing microfluidics devices may add complexity to the top substrate design because each feature in the top substrate may be a different height, making it challenging to compress the microfluidics device evenly.

By contrast, the presently disclosed microfluidics device may comprise a cover plate configured to be disposed over the top substrate. In some embodiments, the cover plate comprises a substantially flat surface that can be pressed evenly to provide even compression throughout the microfluidics device without the need to modify the features of the top substrate (e.g., compression features, ramps, ribs, and well inlets). In some embodiments, the cover plate may provide a consistent gap size between the top and bottom substrates.

The optical detection region 224 and wells (or reservoirs) 216 of top substrate 205 may be susceptible to bubble formation and enlargement due to water vapor from droplets that are in contact with the bubbles. Bubbles may interfere with the use of electrodes in existing assays and protocols. Specifically, bubbles, when nucleated, may consist of a mix of hydrogen peroxide and air. The bubbles may remain trapped in the filler fluid and may enlarge over the course of running a digital microfluidics protocol with fluidic operations and optical analysis. In some embodiments, the microfluidics device described herein may comprise a plurality of vent ports 228 or small-slot vent ports 246 and ramps 240 configured to provide an escape route for the bubbles in both the optical detection region 224 and the optical fiber assembly 122.

### Cover Plate Stickers

Further, like the cover plate 305 shown in FIG. 24A and FIG. 24B, the microfluidics device 100 may provide customized sticker designs. In some embodiments, the sticker may be customized to expose one or more wells 216 (or reservoirs) 216 of the top substrate 205 and/or may serve as a physical barrier to block or cover one or more wells 216 of the top substrate 205. In some embodiments, the sticker may be customized to expose and/or cover one or more wells in a standard 96-well plate, a standard 48-well plate, a standard 12-well plate, or a standard 4-well plate. For example, a 6-column (or 6-channel) sticker may be used to change an 8-column (or 16-channel) microfluidics device 100 to a 6-column (or 12-channel) microfluidics device 100 without the need to change the top substrate 205 or the cover plate 305, thus reducing the need for additional system components. In some embodiments, a single sticker may be used to cover and/or expose multiple wells. In some embodiments, more than one sticker may be used to cover and/or expose multiple wells.

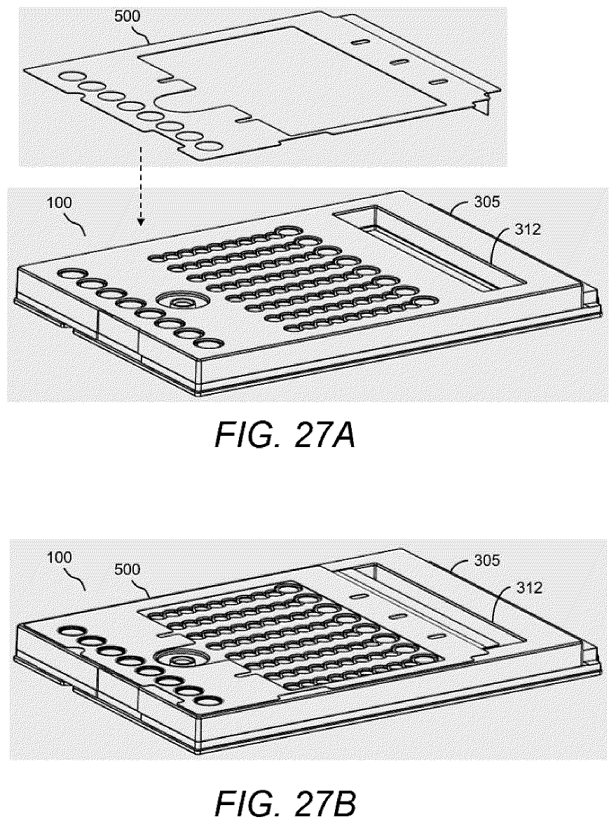

Additionally, in some embodiments, the sticker design may include labeling for guiding a user with respect to using microfluidics device 100. Additionally, in some embodiments, stickers may be used to cover one or more wells 216 of the top substrate 205. Further, in some embodiments, the stickers may be configured to allow for a hole to be punched through the sticker (e.g., the sticker may be pierced), which may allow an operator or a vision-based system (e.g., a machine vision system) to identify or indicate pipette use associated with one or more wells 216. Non-limiting examples of stickers that may be used with the cover plate 305 are shown hereinbelow with reference to FIG. 27A through FIG. 31C.

FIG. 27A shows an example of a sticker 500 that includes a large window for exposing all of the wells 216 of top substrate 205. In some embodiments, the sticker 500 may be adhered to cover plate 305, as shown in FIG. 27B.

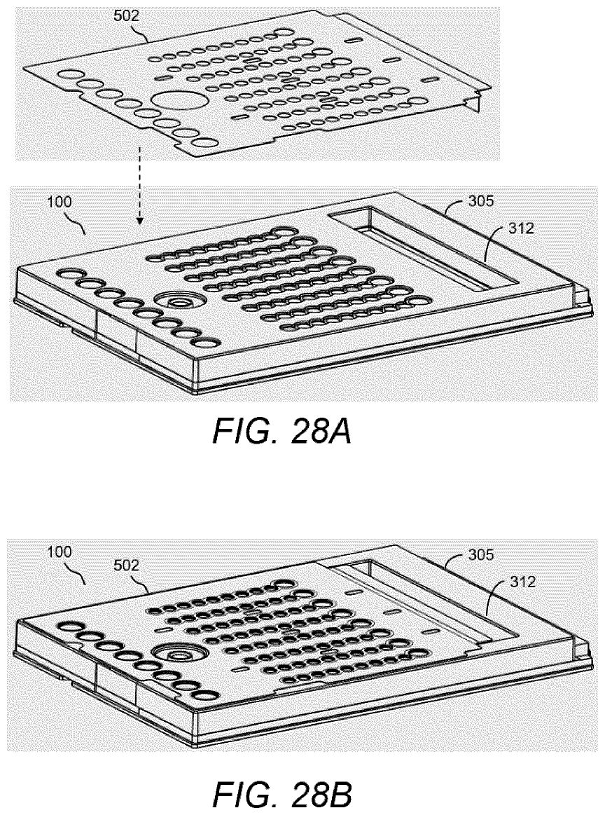

FIG. 28A shows a non-limiting example of a sticker 502 that includes a pattern of eight columns of wells, again for exposing all of the wells of the top substrate 205. In some embodiments, the sticker 502 may be adhered to the cover plate 305, as shown in FIG. 28B.

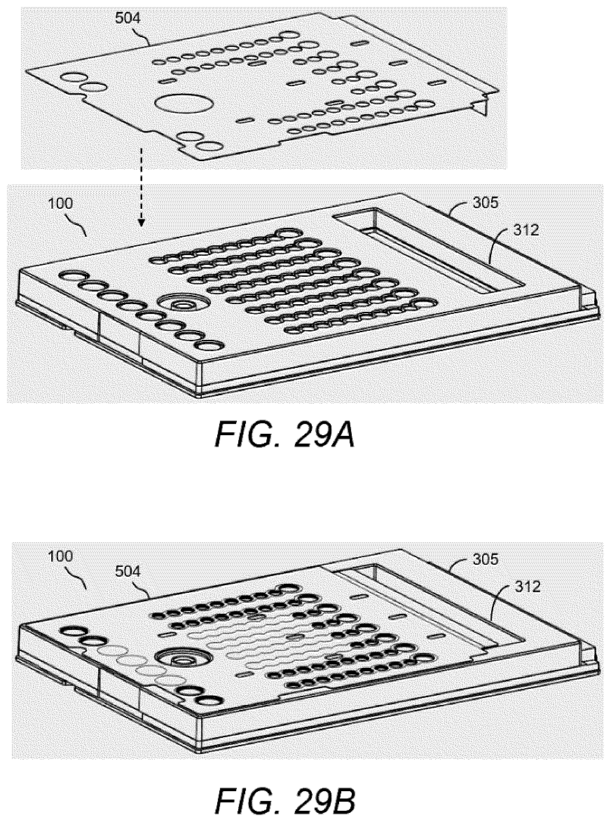

FIG. 29A shows an example of a sticker 504 comprising a pattern for covering one or more wells of top substrate and/or exposing one or more wells of the top substrate 205. In some embodiments, the sticker 504 may be adhered to cover plate 305, as shown in FIG. 29B.

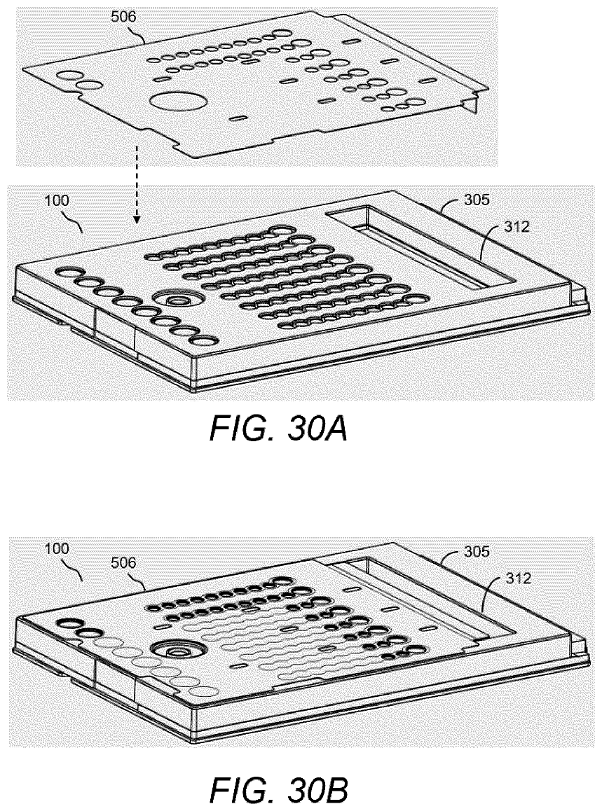

FIG. 30A shows an example of a sticker 506 comprising a pattern for covering one or more wells and/or exposing one or more wells of the top substrate 205. In some embodiments, the sticker 506 may be adhered to cover plate 305, as shown in FIG. 30B.

In one example, stickers 500, 502, 504, and 506 may be single-layer stickers comprising an adhesive on the back side of the sticker 500, 502, 504, and 506, such as a single-layer paper or foil sticker. In some embodiments, the single-layered sticker may comprise one of paper, foil, aluminum, or cardboard. In another example, in some embodiments, stickers 500, 502, 504, and 506 may be multi-layer stickers comprising an adhesive on the back side of the sticker, such as a paper layer and a foil or aluminum layer. In some embodiments, the multi-layered stickers may comprise one or more of cardboard, foil, aluminum, paper, or any combination thereof. In some embodiments, the cardboard of the multi-layered sticker may be configured to provide rigidity to the multi-layered sticker. Further, in some embodiments, stickers 500, 502, 504, and 506 may include labeling (not shown). In some embodiments, the labeling may guide a user with respect to using microfluidics device 100. For example, a certain color or marking may be used to guide the pipette tip into the optimal position relative to the wells 216 of top substrate 205 (e.g., for manual use and/or automation). In some embodiments, a user may use a writing device to label the non-adhesive side of the sticker for labeling.

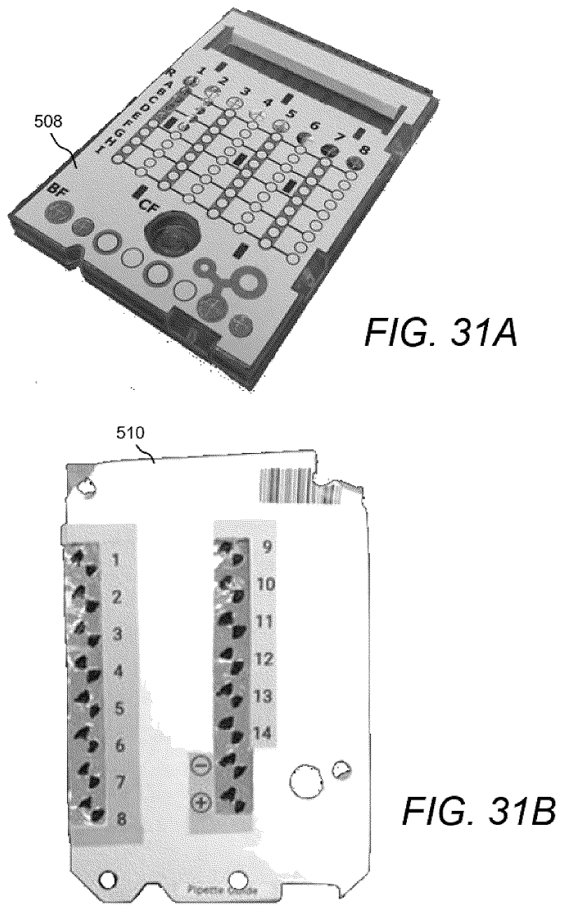

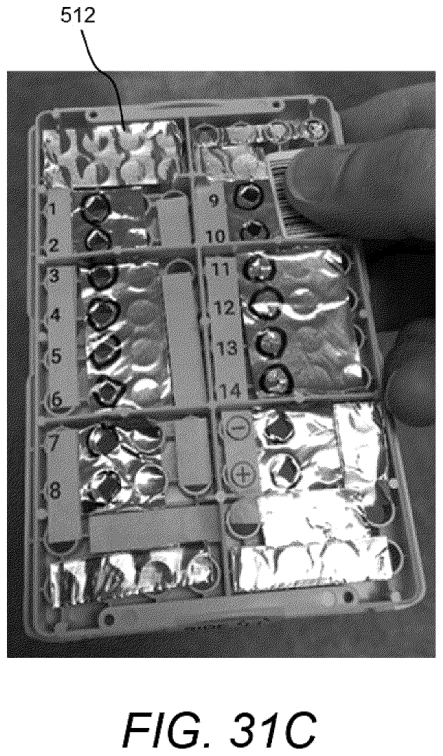

Additionally, FIG. 31A, FIG. 31B, and FIG. 31C show photos of a non-limiting example of a sticker 508, a sticker 510, and a sticker 512, respectively, that may be placed on the cover plate 305 of the presently disclosed microfluidics device 100 shown in FIG. 1A and FIG. 1B. In one example, the sticker 508 of FIG. 31A and the sticker 510 of FIG. 31B may be 2-layer sticker comprising paper and foil. In another example, the sticker 512 of FIG. 31C may be a 1-layer foil sticker. In some embodiments, the sticker may comprise a 1-layer paper sticker or a 1-layer cardboard sticker.

In some embodiments, stickers (e.g., stickers 508, 510, and 512) may be used to show a punch hole to indicate pipette use. For example, FIG. 31B and FIG. 31C show punch marks at the various well locations. An important feature of any of the stickers described herein is that the sticker may not only be indicators of where to punch, but that the punched material (e.g., aluminum foil or paper) may not return to its closed or unpunched state, and additionally may not contaminate the sample in the one or more wells 216, which may ensure a lasting and a clearly visible hole that indicates to a user that the well may already have been used. This indication can also be used in conjunction with a machine vision.

Additionally, stickers (e.g., stickers 508, 510, and 512) may accommodate a color-blind user. In some embodiments, the stickers (e.g., stickers 508, 510, and 512) may accommodate blind users. For example, in some embodiments, stickers (e.g., sticker 508, 510, and 512) may comprise Braille text and/or textured surfaces

In microfluidics device 100, the cover plate 305 may feature a substantially flat surface (as compared to the top substrate 205). The substantially flat surface of the cover plate 305 may not only provides a cleaner and better-looking surface, but may also provide a surface in which a sticker can be attached (e.g., as a third layer). Additionally, in some embodiments, the stickers as described herein may provide, contain, or store information or data, and may include guides, logos, quick response (QR) codes, near field communication (NFC) devices, barcodes, holograms, and the like. In some embodiments, the stickers may also make the cartridges (e.g., microfluidics device 100) look different for different experiments without the need to change the cover plate 305 and/or the top substrate 205. Additionally, in some embodiments, the stickers described herein may contain sensing devices, such as, but not limited to, humidity sensors, temperature sensors, cartridge-was-exposed-to-air indicators, and the like.

Although the foregoing subject matter has been described in some detail by way of illustration and example for purposes of clarity of understanding, it will be understood by those skilled in the art that certain changes and modifications can be practiced within the scope of the appended claims.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the invention has been disclosed in connection with specific preferred aspects or embodiments, it should be understood that the invention as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. As used herein, the term “about” in some cases refers to an amount that is approximately the stated amount. As used herein, the term “about” refers to an amount that is near the stated amount by 10%, 5%, or 1%, including increments therein. As used herein, the term “about” in reference to a percentage refers to an amount that is greater or less the stated percentage by 10%, 5%, or 1%, including increments therein.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components.

“Droplet Actuator” means a device for manipulating droplets. Microfluidics devices, microfluidics cartridges, digital microfluidics (DMF) devices, and DMF cartridges are examples of droplet actuators. Certain droplet actuators may include one or more substrates arranged with a droplet operations gap therebetween and electrodes associated with (e.g., patterned on, layered on, attached to, and/or embedded in) the one or more substrates and arranged to conduct one or more droplet operations. For example, certain droplet actuators may include a base (or bottom) substrate, droplet operations electrodes associated with the substrate, one or more dielectric layers disposed over the substrate and/or electrodes, and optionally one or more hydrophobic layers disposed over the substrate, dielectric layers and/or the electrodes forming a droplet operations surface. A top substrate may also be provided, which is separated from the droplet operations surface by a gap, commonly referred to as a droplet operations gap. Droplet actuators may include various electrode arrangements on the bottom and/or top substrates. During droplet operations it is preferred that droplets remain in continuous contact or frequent contact with a ground or reference electrode. A ground or reference electrode may be associated with the top substrate facing the gap, the bottom substrate facing the gap, or within the gap itself. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. Where multiple substrates are used, a spacer may be provided between the substrates to determine the height of the gap therebetween and define on-actuator dispensing reservoirs. The spacer height may, for example, be from about 5 μm to about 1000 μm, or about 100 μm to about 400 μm, or about 200 μm to about 350 μm, or about 250 μm to about 300 μm, or about 275 μm. The spacer may, for example, be formed of features or layers projecting from the top or bottom substrates, and/or a material inserted between the top and bottom substrates. One or more openings may be provided in the one or more substrates for forming a fluid path through which liquid may be delivered into the droplet operations gap.

In some cases, the top and/or bottom substrate of a droplet actuator includes a PCB substrate that is coated with a dielectric, such as a polyimide dielectric, which may in some cases also be coated or otherwise treated to make the droplet operations surface hydrophobic. Various materials are also suitable for use as the dielectric component of the droplet actuator. In some cases, the top and/or bottom substrate of a droplet actuator includes a glass or silicon substrate on which features have been patterned using process technology borrowed from semiconductor device fabrication including the deposition and etching of thin layers of materials using microlithography. The top and/or bottom substrate may consist of a semiconductor backplane (e.g., a thin-film transistor (TFT) active-matrix controller) on which droplet operations electrodes have been formed.

Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity, low-surface tension oil, such as silicone oil or hexadecane. The filler fluid may be or include a halogenated oil, such as a fluorinated or perfluorinated oil. The filler fluid may fill the entire gap of the droplet actuator or may only coat one or more surfaces of the droplet actuator or may only surround a droplet (e.g., an “oil-shell”) and the droplet brings its own oil with it. Filler fluids may be selected to improve droplet operations and/or reduce loss of reagent or target substances from droplets, reduce formation of unwanted microdroplets, reduce cross contamination between droplets, reduce contamination of droplet actuator surfaces, reduce degradation of droplet actuator materials, reduce evaporation of droplets, etc. For example, filler fluids may be selected for compatibility with droplet actuator materials. As an example, fluorinated filler fluids may be usefully employed with fluorinated surface coatings. In another example, fluorinated filler fluids may be used to dissolve surface coatings (e.g., Fluorinert fc-40 may be a solvent for Teflon AF). Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents or samples used in the specific assay protocols and effective interaction or non-interaction with droplet actuator materials. For example, fluorinated oils may in some cases be doped with fluorinated surfactants, e.g., Zonyl FSO-100 (Sigma-Aldrich) and/or others.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the invention shall also cover any such alternatives, modifications, variations or equivalents. It is intended that the following claims define the scope of the disclosure and that methods and structures within the scope of these claims and their equivalents be covered thereby.

1. A microfluidics device comprising:
a bottom plate comprising one or more electrodes configured for performing droplet operations in a droplet operations gap formed between the bottom plate and a top plate, the top plate having a top surface comprising one or more irregularities or protrusions such the top surface is non-planar; and
a cover plate configured to be disposed over the top plate, the cover plate comprising one or more alignment features for positioning the cover plate with respect to the one or more irregularities or protrusions of the top surface of the top plate.

2. The microfluidics device of claim 1, wherein the cover plate is configured to apply a force to the top plate to maintain one or more properties of the droplet operations gap.

3. The microfluidics device of claim 2, wherein the one or more properties of the droplet operations gap is one or more dimensions of the droplet operations gap, wherein the one or more dimensions of the droplet operations gap is a height of the droplet operations gap.

4. (canceled)

5. (canceled)

6. The microfluidics device of claim 1, wherein the one or more irregularities or protrusions of the top surface of the top plate corresponds to one or more wells or reservoirs of the top plate that form a fluid path between an exterior of the microfluidics device and the droplet operations gap.

7. The microfluidics device of claim 6, wherein the cover plate has one or more openings corresponding to one or more wells or reservoirs of the top plate allowing access to the one or more wells or reservoirs.

8. (canceled)

9. The microfluidics device of claim 9, wherein the cover plate is configured to reduce evaporation of a fluid deposited in the one or more wells or reservoirs of the top plate.

10. The microfluidics device of claim 1, wherein the top plate comprises one or more vent ports for venting the droplet operations gap.

11. The microfluidics device of claim 10, wherein the one or more vent ports are positioned over the one or more electrodes of the bottom plate.

12. The microfluidics device of claim 10, wherein the cover plate does not form an air tight seal with the top plate thereby allowing the one or more vent ports of the top plate to vent.

13. The microfluidics device of claim 1, wherein when disposed thereon the cover plate and the top plate form a gap therebetween.

14. The microfluidics device of claim 13, wherein the gap between the cover plate and top plate is configured to store or retain additional elements of the microfluidic device.

15. The microfluidics device of claim 1, wherein the cover plate is configured to be coupled to the top plate using any one of a friction fit, an adhesive bond, a snap-fit, fasteners, or any combination thereof.

16. (canceled)

17. The microfluidics device of claim 1, wherein the cover plate is configured to interface with the top plate irrespective of the position of the one or more irregularities or protrusions.

18. The microfluidics device of claim 7, further comprising an adhesive film configured to positioned over the at least a portion of the cover plate.

19.-23. (canceled)

24. The microfluidics device of claim 18, wherein the adhesive film may provide, contain, or store information or data using one or more guides, logos, quick response (QR) codes, near field communication (NFC) devices, barcodes, holograms, or any combination thereof.

25. (canceled)

26. The microfluidics device of claim 7, wherein the one or more irregularities or protrusions of the top surface of the top plate do not extend through the one or more openings of the cover plate.

27. The microfluidics device of claim 1, wherein the cover plate has an identifier disposed on a surface of the cover plate.

28. The microfluidics device of claim 27, wherein the identifier is a quick response (QR) code or near field communication (NFC) device.
